(19) United States
(12) Patent Application Publication
(10) Pub. No.: US 2024/0040404 A1
(43) Pub. Date: Feb. 1, 2024

(54) OUT-OF-DISTRIBUTION DETECTION AND REPORTING FOR MACHINE LEARNING MODEL DEPLOYMENT

(71) Applicant: QUALCOMM Incorporated, San Diego, CA (US)

(72) Inventors: Yuwei REN, Beijing (CN); Yu ZHANG, San Diego, CA (US); Chenxi HAO, Beijing (CN); Huilin XU, Temecula, CA (US)

(21) Appl. No.: 18/258,314

(22) PCT Filed: Feb. 24, 2021
(86) PCT No.: PCT/CN2021/077631

§ 371 Date: Jun. 19, 2023

(51) Int. Cl. H04W 24/02; H04L 41/16; G06N 20/20

(52) U.S. Cl. CPC H04W 24/02; H04L 41/16; G06N 20/20

(57) ABSTRACT

Methods, systems, and devices for wireless communications are described. A user equipment (UE) may detect whether a data sample falls outside of a dataset used to train a machine learning model configured by a network device. For example, a base station may transmit control signaling to the UE to indicate an out-of-distribution (OOD) detection rule configuration that the UE uses to determine whether at least one data sample falls outside of the dataset. If the at least one data sample is determined to fall outside of the dataset using the OOD detection rule configuration, the UE may transmit an indication to the base station that indicates an OOD event has occurred for the at least one sample. Additionally, the base station may parameters for determining the OOD event, OOD detection patterns to indicate when to monitor for the OOD event, or a combination thereof.

### CROSS REFERENCES

The present Application is a 371 national stage filing of International PCT Application No. PCT/CN2021/077631 by REN et al. entitled “OUT-OF-DISTRIBUTION DETECTION AND REPORTING FOR MACHINE LEARNING MODEL DEPLOYMENT,” filed Feb. 24, 2021, which is assigned to the assignee hereof, and which is expressly incorporated by reference in its entirety herein.

### FIELD OF TECHNOLOGY

The following relates to wireless communications, including out-of-distribution (OOD) detection and reporting for machine learning model deployment.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support out-of-distribution (OOD) detection and reporting for machine learning model deployment. Generally, the described techniques provide for a user equipment (UE) to detect whether a data sample falls outside of a dataset used to train a machine learning model configured (at least in part) by a network device (e.g., a base station). For example, a base station may transmit control signaling to the UE to indicate an OOD detection rule configuration that the UE uses to determine whether at least one data sample falls outside of the dataset. If the at least one data sample is determined to fall outside of the dataset using the OOD detection rule configuration, the UE may transmit an indication to the base station that indicates an OOD event has occurred for the at least one sample.

In some examples, the base station may transmit the indication of the OOD detection rule configuration with a machine learning model configuration or separately from the machine learning model configuration. Additionally, the OOD detection rule configuration may include an indication of a probability distribution range, a confidence value threshold, a reconstruction error threshold, a feature statistics distribution (FSD) range, or a combination thereof, where the UE determines the at least one data sample falls outside the dataset based on one of these ranges or threshold values. In some examples, the base station may also transmit an indication of an OOD detection pattern (e.g., an explicit OOD detection pattern or an implicit OOD detection pattern) that the UE uses to identify when to monitor for and report OOD events. Additionally, when transmitting the indication that the OOD event has occurred for the at least one data sample, the UE may transmit a measurement value for the at least one data sample. The UE may transmit the indication that the OOD event has occurred based on a reporting trigger, a pre-defined reporting pattern, a reporting configuration, or a combination thereof.

A method for wireless communications at a UE is described. The method may include receiving, from a base station, control signaling indicating an OOD detection rule configuration for detecting a data sample that falls outside of a dataset used to train a first machine learning model, determining that an OOD detection event has occurred based on determining that at least one data sample generated by the first machine learning model falls outside of the dataset based on the OOD detection rule configuration, and transmitting, to the base station, an indication that the OOD detection event has been determined for the at least one data sample.

An apparatus for wireless communications at a UE is described. The apparatus may include a processor, memory coupled with the processor, and instructions stored in the memory. The instructions may be executable by the processor to cause the apparatus to receive, from a base station, control signaling indicating an OOD detection rule configuration for detecting a data sample that falls outside of a dataset used to train a first machine learning model, determine that an OOD detection event has occurred based on determining that at least one data sample generated by the first machine learning model falls outside of the dataset based on the OOD detection rule configuration, and transmit, to the base station, an indication that the OOD detection event has been determined for the at least one data sample.

Another apparatus for wireless communications at a UE is described. The apparatus may include means for receiving, from a base station, control signaling indicating an OOD detection rule configuration for detecting a data sample that falls outside of a dataset used to train a first machine learning model, means for determining that an OOD detection event has occurred based on determining that at least one data sample generated by the first machine learning model falls outside of the dataset based on the OOD detection rule configuration, and means for transmitting, to the base station, an indication that the OOD detection event has been determined for the at least one data sample.

A non-transitory computer-readable medium storing code for wireless communications at a UE is described. The code may include instructions executable by a processor to receive, from a base station, control signaling indicating an OOD detection rule configuration for detecting a data sample that falls outside of a dataset used to train a first machine learning model, determine that an OOD detection event has occurred based on determining that at least one data sample generated by the first machine learning model falls outside of the dataset based on the OOD detection rule configuration, and transmit, to the base station, an indication that the OOD detection event has been determined for the at least one data sample.

In some examples of the method, apparatuses, and non-transitory computer-readable medium described herein, receiving the control signaling may include operations, features, means, or instructions for receiving, from the base station, the control signaling that indicates a model configuration for configuring the first machine learning model to generate the at least one data sample and that indicates the OOD detection rule configuration for configuring a second machine learning model for detecting data samples that fall outside of the dataset used to train the first machine learning model.

In some examples of the method, apparatuses, and non-transitory computer-readable medium described herein, receiving the control signaling may include operations, features, means, or instructions for receiving, from the base station, the control signaling that indicates a model configuration for configuring the first machine learning model to generate the at least one data sample and detect data samples that fall outside of the dataset used to train the first machine learning model.

In some examples of the method, apparatuses, and non-transitory computer-readable medium described herein, receiving the control signaling may include operations, features, means, or instructions for receiving the control signaling that jointly configures the UE with the OOD detection rule configuration and a model configuration for the first machine learning model.

In some examples of the method, apparatuses, and non-transitory computer-readable medium described herein, receiving the control signaling may include operations, features, means, or instructions for receiving the control signaling that indicates the OOD detection rule configuration that is a common OOD detection rule configuration for a set of multiple machine learning models.

In some examples of the method, apparatuses, and non-transitory computer-readable medium described herein, receiving the control signaling may include operations, features, means, or instructions for receiving the control signaling indicating the OOD detection rule configuration that indicates a probability distribution range for a probability distribution for data samples generated by the first machine learning model.

In some examples of the method, apparatuses, and non-transitory computer-readable medium described herein, transmitting the indication that the OOD detection event may have been determined may include operations, features, means, or instructions for transmitting the indication based on the at least one data sample falling outside of the probability distribution range.

In some examples of the method, apparatuses, and non-transitory computer-readable medium described herein, receiving the control signaling may include operations, features, means, or instructions for receiving the control signaling indicating the OOD detection rule configuration that indicates a confidence value threshold for the first machine learning model.

In some examples of the method, apparatuses, and non-transitory computer-readable medium described herein, transmitting the indication that the OOD detection event may have been determined may include operations, features, means, or instructions for transmitting the indication based on the at least one data sample satisfying the confidence value threshold.

In some examples of the method, apparatuses, and non-transitory computer-readable medium described herein, receiving the control signaling may include operations, features, means, or instructions for receiving the control signaling indicating the OOD detection rule configuration that indicates a reconstruction error threshold for the first machine learning model.

In some examples of the method, apparatuses, and non-transitory computer-readable medium described herein, transmitting the indication that the OOD detection event may have been determined may include operations, features, means, or instructions for transmitting the indication based on the at least one data sample satisfying the reconstruction error threshold.

In some examples of the method, apparatuses, and non-transitory computer-readable medium described herein, receiving the control signaling may include operations, features, means, or instructions for receiving the control signaling indicating the OOD detection rule configuration that indicates an FSD range and a latent feature location for the first machine learning model.

In some examples of the method, apparatuses, and non-transitory computer-readable medium described herein, transmitting the indication that the OOD detection event may have been determined may include operations, features, means, or instructions for transmitting the indication based on the at least one data sample falling outside of the FSD range relative to the latent feature location.

In some examples of the method, apparatuses, and non-transitory computer-readable medium described herein, receiving the control signaling may include operations, features, means, or instructions for receiving the control signaling indicating the OOD detection rule configuration that indicates an OOD detection pattern, where the at least one data sample may be determined to fall outside of the dataset according to the OOD detection pattern.

In some examples of the method, apparatuses, and non-transitory computer-readable medium described herein, the OOD detection pattern indicates a fixed period of instances for the UE to determine whether one or more data samples generated by the first machine learning model fall outside of the dataset used to train the first machine learning model.

In some examples of the method, apparatuses, and non-transitory computer-readable medium described herein, the OOD detection pattern indicates specific instances for the UE to determine whether one or more data samples generated by the first machine learning model fall outside of the dataset used to train the first machine learning model.

Some examples of the method, apparatuses, and non-transitory computer-readable medium described herein may further include operations, features, means, or instructions for receiving the control signaling indicating the OOD detection rule configuration that indicates one or more parameters to implicitly indicate an OOD detection pattern.

In some examples of the method, apparatuses, and non-transitory computer-readable medium described herein, transmitting the indication that the OOD detection event may have been determined may include operations, features, means, or instructions for transmitting the indication that indicates a measurement value for the at least one data sample.

In some examples of the method, apparatuses, and non-transitory computer-readable medium described herein, transmitting the indication that the OOD detection event may have been determined may include operations, features, means, or instructions for transmitting the indication that the OOD detection event may have been determined based on a reporting trigger condition being satisfied, a pre-defined reporting pattern, a reporting configuration, or a combination thereof.

A method for wireless communications at a base station is described. The method may include transmitting, to a UE, control signaling indicating an OOD detection rule configuration for configuring the UE to detect data samples that fall outside of a dataset used to train a first machine learning model of the UE and receiving, from the UE, an indication that an OOD detection event has been determined for at least one data sample generated by the first machine learning model indicating that the at least one data sample falls outside of the dataset according to the OOD detection rule configuration.

An apparatus for wireless communications at a base station is described. The apparatus may include a processor, memory coupled with the processor, and instructions stored in the memory. The instructions may be executable by the processor to cause the apparatus to transmit, to a UE, control signaling indicating an OOD detection rule configuration for configuring the UE to detect data samples that fall outside of a dataset used to train a first machine learning model of the UE and receive, from the UE, an indication that an OOD detection event has been determined for at least one data sample generated by the first machine learning model indicating that the at least one data sample falls outside of the dataset according to the OOD detection rule configuration.

Another apparatus for wireless communications at a base station is described. The apparatus may include means for transmitting, to a UE, control signaling indicating an OOD detection rule configuration for configuring the UE to detect data samples that fall outside of a dataset used to train a first machine learning model of the UE and means for receiving, from the UE, an indication that an OOD detection event has been determined for at least one data sample generated by the first machine learning model indicating that the at least one data sample falls outside of the dataset according to the OOD detection rule configuration.

A non-transitory computer-readable medium storing code for wireless communications at a base station is described. The code may include instructions executable by a processor to transmit, to a UE, control signaling indicating an OOD detection rule configuration for configuring the UE to detect data samples that fall outside of a dataset used to train a first machine learning model of the UE and receive, from the UE, an indication that an OOD detection event has been determined for at least one data sample generated by the first machine learning model indicating that the at least one data sample falls outside of the dataset according to the OOD detection rule configuration.

In some examples of the method, apparatuses, and non-transitory computer-readable medium described herein, transmitting the control signaling may include operations, features, means, or instructions for transmitting, to the UE, the control signaling that indicates a model configuration for configuring the first machine learning model to generate the at least one data sample and that indicates the OOD detection rule configuration for configuring a second machine learning model for detecting data samples that fall outside of the dataset used to train the first machine learning model.

In some examples of the method, apparatuses, and non-transitory computer-readable medium described herein, transmitting the control signaling may include operations, features, means, or instructions for transmitting, to the UE, the control signaling that indicates a model configuration for configuring the first machine learning model to generate the at least one data sample and detect data samples that fall outside of the dataset used to train the first machine learning model.

In some examples of the method, apparatuses, and non-transitory computer-readable medium described herein, transmitting the control signaling may include operations, features, means, or instructions for transmitting the control signaling that jointly configures the UE with the OOD detection rule configuration and a model configuration for the first machine learning model.

In some examples of the method, apparatuses, and non-transitory computer-readable medium described herein, transmitting the control signaling may include operations, features, means, or instructions for transmitting the control signaling that indicates the OOD detection rule configuration that may be a common OOD detection rule configuration for a set of multiple machine learning models.

In some examples of the method, apparatuses, and non-transitory computer-readable medium described herein, transmitting the control signaling may include operations, features, means, or instructions for transmitting the control signaling indicating the OOD detection rule configuration that indicates a probability distribution range for a probability distribution for data samples generated by the first machine learning model.

In some examples of the method, apparatuses, and non-transitory computer-readable medium described herein, receiving the indication that the OOD detection event may have been determined may include operations, features, means, or instructions for receiving the indication based on the at least one data sample falling outside of the probability distribution range.

In some examples of the method, apparatuses, and non-transitory computer-readable medium described herein, transmitting the control signaling may include operations, features, means, or instructions for transmitting the control signaling indicating the OOD detection rule configuration that indicates a confidence value threshold for the first machine learning model.

In some examples of the method, apparatuses, and non-transitory computer-readable medium described herein, receiving the indication that the OOD detection event may have been determined may include operations, features, means, or instructions for receiving the indication based on the at least one data sample satisfying the confidence value threshold.

In some examples of the method, apparatuses, and non-transitory computer-readable medium described herein, transmitting the control signaling may include operations, features, means, or instructions for transmitting the control signaling indicating the OOD detection rule configuration that indicates a reconstruction error threshold for the first machine learning model.

In some examples of the method, apparatuses, and non-transitory computer-readable medium described herein, receiving the indication that the OOD detection event may have been determined may include operations, features, means, or instructions for receiving the indication based on the at least one data sample satisfying the reconstruction error threshold.

In some examples of the method, apparatuses, and non-transitory computer-readable medium described herein, transmitting the control signaling may include operations, features, means, or instructions for transmitting the control signaling indicating the OOD detection rule configuration that indicates an FSD range and a latent feature location for the first machine learning model.

In some examples of the method, apparatuses, and non-transitory computer-readable medium described herein, receiving the indication that the OOD detection event may have been determined may include operations, features, means, or instructions for receiving the indication based on the at least one data sample falling outside of the FSD range relative to the latent feature location.

In some examples of the method, apparatuses, and non-transitory computer-readable medium described herein, transmitting the control signaling may include operations, features, means, or instructions for transmitting the control signaling indicating the OOD detection rule configuration that indicates an OOD detection pattern, where the at least one data sample may be determined to fall outside of the dataset according to the OOD detection pattern.

In some examples of the method, apparatuses, and non-transitory computer-readable medium described herein, the OOD detection pattern indicates a fixed period of instances for the UE to determine whether one or more data samples generated by the first machine learning model fall outside of the dataset used to train the first machine learning model.

In some examples of the method, apparatuses, and non-transitory computer-readable medium described herein, the OOD detection pattern indicates specific instances for the UE to determine whether one or more data samples generated by the first machine learning model fall outside of the dataset used to train the first machine learning model.

In some examples of the method, apparatuses, and non-transitory computer-readable medium described herein, transmitting the control signaling may include operations, features, means, or instructions for transmitting the control signaling indicating the OOD detection rule configuration that indicates one or more parameters to implicitly indicate an OOD detection pattern.

In some examples of the method, apparatuses, and non-transitory computer-readable medium described herein, receiving the indication that the OOD detection event may have been determined may include operations, features, means, or instructions for receiving the indication that indicates a measurement value for the at least one data sample.

In some examples of the method, apparatuses, and non-transitory computer-readable medium described herein, receiving the indication that the OOD detection event may have been determined may include operations, features, means, or instructions for receiving the indication that the OOD detection event may have been determined based on a reporting trigger condition being satisfied, a pre-defined reporting pattern, a reporting configuration, or a combination thereof.

### BRIEF DESCRIPTION OF THE DRAWINGS

FIG. 1 illustrates an example of a wireless communications system that supports out-of-distribution (OOD) detection and reporting for machine learning model deployment in accordance with aspects of the present disclosure.

FIG. 2 illustrates an example of a wireless communications system that supports OOD detection and reporting for machine learning model deployment in accordance with aspects of the present disclosure.

FIGS. 3A and 3B illustrate an example of a machine learning model preparation and an example of a machine learning model deployment in accordance with aspects of the present disclosure.

FIG. 4 illustrates an example of a distribution in accordance with aspects of the present disclosure.

FIGS. 5A and 5B illustrate examples of machine learning applications in accordance with aspects of the present disclosure.

FIGS. 6A and 6B illustrate examples of OOD detection model indications that support OOD detection and reporting for machine learning model deployment in accordance with aspects of the present disclosure.

FIGS. 7A, 7B, 7C, and 7D illustrate examples of OOD detection configurations that support OOD detection and reporting for machine learning model deployment in accordance with aspects of the present disclosure.

FIGS. 8A, 8B, and 8C illustrate examples of OOD detection patterns that support OOD detection and reporting for machine learning model deployment in accordance with aspects of the present disclosure.

FIG. 9 illustrates an example of a process flow that supports OOD detection and reporting for machine learning model deployment in accordance with aspects of the present disclosure.

FIGS. 10 and 11 show block diagrams of devices that support OOD detection and reporting for machine learning model deployment in accordance with aspects of the present disclosure.

FIG. 12 shows a block diagram of a communications manager that supports OOD detection and reporting for machine learning model deployment in accordance with aspects of the present disclosure.

FIG. 13 shows a diagram of a system including a device that supports OOD detection and reporting for machine learning model deployment in accordance with aspects of the present disclosure.

FIGS. 14 and 15 show block diagrams of devices that support OOD detection and reporting for machine learning model deployment in accordance with aspects of the present disclosure.

FIG. 16 shows a block diagram of a communications manager that supports OOD detection and reporting for machine learning model deployment in accordance with aspects of the present disclosure.

FIG. 17 shows a diagram of a system including a device that supports OOD detection and reporting for machine learning model deployment in accordance with aspects of the present disclosure.

FIGS. 18 through 25 show flowcharts illustrating methods that support OOD detection and reporting for machine learning model deployment in accordance with aspects of the present disclosure.

### DETAILED DESCRIPTION

In some wireless communications systems, machine learning models may be deployed on devices (e.g., user equipments (UEs)) for different applications (e.g., prediction, classification, compression, regression, or other targets). A machine learning model may be trained on a dataset. When real-world data is input, the machine learning model may generate an output based on the real-world data. Accordingly, the dataset used to train a machine learning model may affect how the model performs. However, the dataset used to train the machine learning model may not cover all of the variability in real-world data. When the model receives real-world data that is unlike the data used to train the model, the model may fail such that its output is unpredictable. This is referred to as an out-of-distribution (OOD) event. Conventional techniques do not adequately identify when a machine learning model encounters an OOD event.

As described herein, a network device (e.g., a base station) may configure and indicate an OOD detection rule configuration to a UE to enable the UE to detect data samples that fall outside of a dataset used to train a corresponding machine learning model. Using this OOD detection rule configuration, the UE may then determine when at least one data sample generated by the machine learning model falls outside of the training dataset and may transmit an indication of an OOD detection event to the base station. In some examples, the OOD detection rule configuration may include rules for determining if a data sample falls outside of the machine learning model based on a probability distribution of data sample outputs by the machine learning model, a confidence value of a given data sample, a reconstruction error of a generated model for a given data sample using the machine learning model, a feature statistics distribution (FSD) of an output of a latent feature for the machine learning model, or a combination thereof. Additionally, the network device may configure the UE with an OOD detection pattern specifying when the UE is to determine whether data sample(s) generated by the machine learning model fall outside of the training dataset. When the OOD event is detected, the UE may report to the base station that the OOD event has occurred and, optionally, may report a measurement value of the at least one data sample generated by the machine learning model.

Aspects of the disclosure are initially described in the context of wireless communications systems. Additionally, aspects of the disclosure are illustrated by an additional wireless communications system, a machine learning model preparation, a machine learning model deployment, a distribution, machine learning applications, OOD detection model indications, OOD detection configurations, OOD detection patterns, and a process flow. Aspects of the disclosure are further illustrated by and described with reference to apparatus diagrams, system diagrams, and flowcharts that relate to OOD detection and reporting for machine learning model deployment.

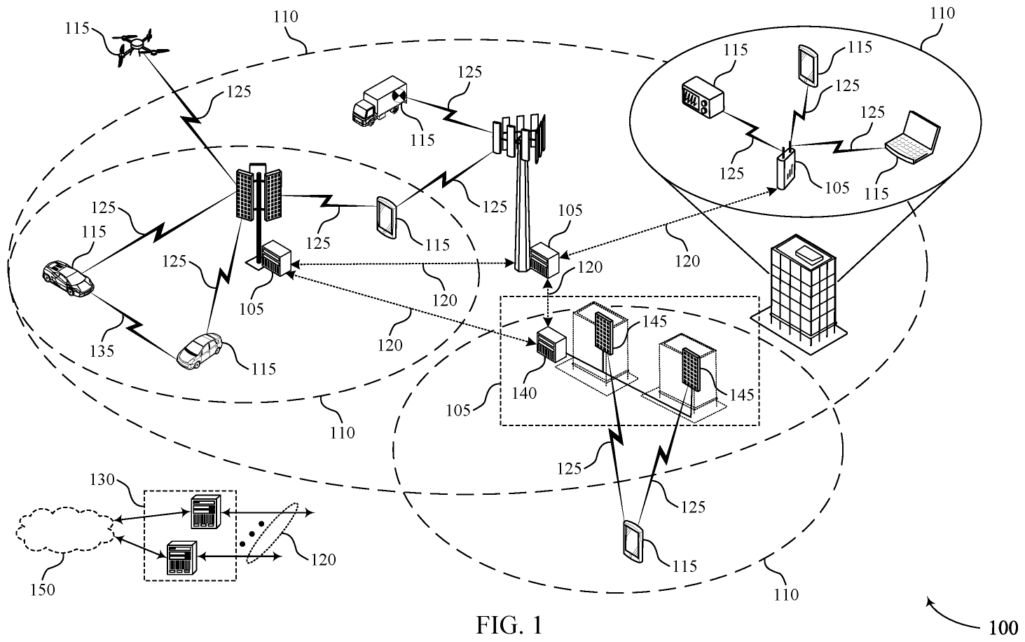

FIG. 1 illustrates an example of a wireless communications system 100 that supports OOD detection and reporting for machine learning model deployment in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of T, =1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARM) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some wireless communications systems, machine learning models may be deployed on devices (e.g., UEs 115) for different applications (e.g., prediction, classification, compression, regression, or other targets). For example, the machine learning model may include one or more parameters (e.g., prepared datasets) that, when identified by the devices, enable or support a corresponding application at the devices. To build and further train the machine learning models, a network device may collect different datasets to identify implications or effects of the datasets for the different applications. That is, a machine learning model may be trained on one or more datasets, and when real-world data is input to the machine learning model, the machine learning model may generate an output based on the dataset. Accordingly, the quality of the datasets (e.g., accuracy and diversity of the datasets) may affect how the machine learning models perform.

However, the one or more datasets used to train the machine learning model may not cover all of the variability in real-world data (e.g., the datasets may not capture all possible scenarios for the different applications). For example, in a deployment for a machine learning model, a data sample from a new environment (e.g., an environment not captured by the different collected datasets used to train the machine learning model) may hold different features from the dataset(s) used in the preparation of the machine learning model. Accordingly, this data sample may be considered to be out of the distribution (e.g., OOD) compared to previously logged dataset(s) in the distribution of data used for training the machine learning model (e.g., in-distribution). When the model receives real-world data that is unlike the data used to train the model (e.g., OOD events), the model may fail such that its output is unpredictable.

In some examples, OOD events may be unavoidable and may include accidental events with low probabilities of occurring. For example, a probability of an OOD event occurring during a deployment of a machine learning model may be lower than 0.05%. In wireless communications, OOD events may be more serious based on the wireless communications environment being more complicated and always changing. Additionally, the mobility of UEs 115 may further increase the uncertainty of the wireless communications environment (e.g., conditions may vary from location to location). Actual capabilities of a device on which the machine learning model is deployed (e.g., a UE 115) may constrain large and advanced machine learning model applications on the device side (e.g., UE side). Additionally, it may be difficult to prepare and train a machine learning model to match the different variations experienced in the wireless communications environment. When the adaptation between a machine learning model and the environment in which the machine learning model is trained is out of date, OOD events may occur, which leads to a failing of the machine learning model.

In order to adaptively fit environment variations, the network may make a real-time configuration for a machine learning model. With making a real-time configuration, a first challenge may include how to detect OOD events, and a second challenge may include how to report the OOD events to trigger an update for the machine learning model. Conventional techniques may not adequately identify when a machine learning model encounters an OOD event or how the devices may report such OOD events.

As described herein, wireless communications system 100 may support a procedure and related signaling to support OOD detection for a machine learning model. For example, a base station 105 (e.g., a network device) may configure and indicate an OOD detection rule configuration to a UE 115 to enable the UE 115 to detect data samples that fall outside of a logged dataset used to train the machine learning model. In some examples, the base station 105 may indicate the OOD detection rule configuration separately from a model configuration for the machine learning model or embedded within the machine learning model. Using this OOD detection rule configuration, the UE 115 may then determine that at least one data sample falls outside of the machine learning model and may transmit an indication of an OOD detection based on the determination. In some examples, the OOD detection rule configuration may include rules for determining if a data sample falls outside of the machine learning model based on different ranges or values, where the UE may optionally report a measurement value based on the different ranges or values for the at least one data sample when reporting the indication of the OOD detection. Additionally, the base station 105 may indicate when the UE 115 is to monitor for and report OOD events (e.g., via OOD detection patterns). By using the OOD detection rule configuration, the base station 105 and the UE 115 may ensure the accuracy of the machine learning model deployment, and the OOD event detections may provide information for updates to the machine learning model.

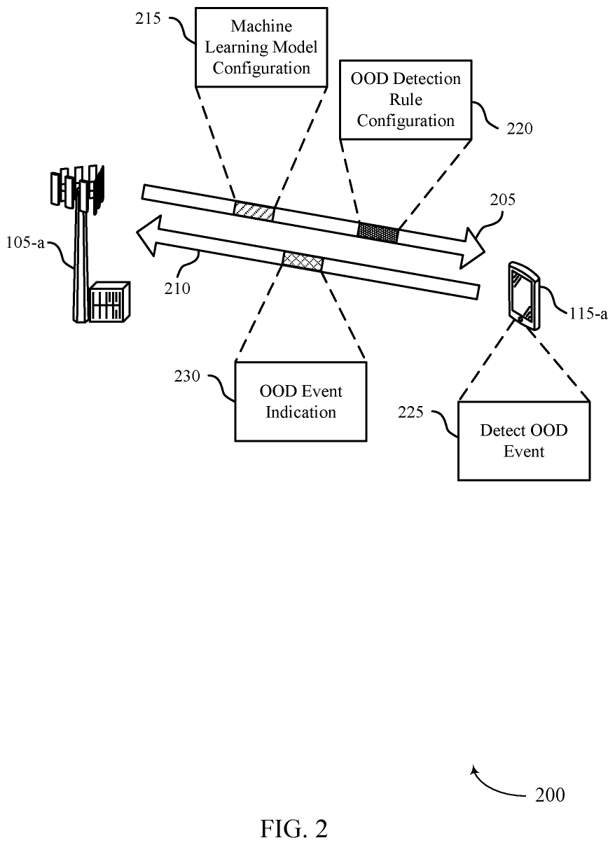

FIG. 2 illustrates an example of a wireless communications system 200 that supports OOD detection and reporting for machine learning model deployment in accordance with aspects of the present disclosure. In some examples, wireless communications system 200 may implement aspects of or may be implemented by aspects of the wireless communications system 100. For example, wireless communications system 200 may include a base station 105-a and a UE 115-a, which may represent examples of base stations 105 and UEs 115, respectively, as described with reference to FIG. 1. Additionally, base station 105-a and UE 115-a may communicate on resources of a carrier 205 (e.g., for downlink communications) and of a carrier 210 (e.g., for uplink communications). Although shown as separate carriers, carrier 205 and carrier 210 may include same or different resources (e.g., time and frequency resources) for the corresponding transmissions.

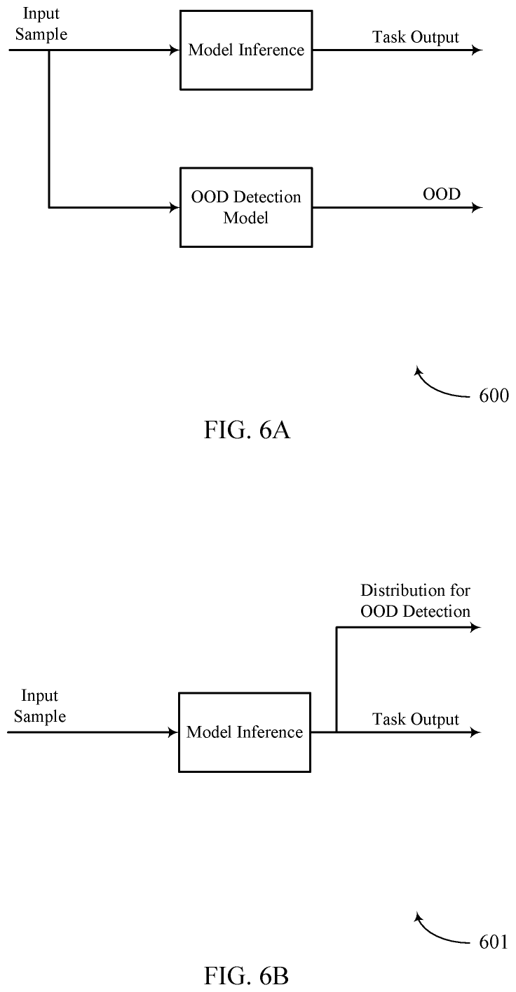

As described herein, base station 105-a and UE 115-a may detect and report OOD events for a machine learning model deployment at UE 115-a (e.g., whether OOD events occur for a machine learning model deployed on UE 115-a). For example, an overall procedure for detecting and reporting the OOD events may include multiple steps or operations. As part of a first step or operation of the procedure for detecting and reporting OOD events, base station 105-a may configure a machine learning model along with a corresponding set of OOD detection rules, wherein the set may include one or more OOD detection rules. Additionally, base station 105-a may transmit a machine learning model configuration 215 and an OOD detection rule configuration 220 to UE 115-a (e.g., via carrier 205). In some example, machine learning model configuration 215 may include one task model (e.g., a task that can be run using the machine learning model) and one OOD detection model (e.g., the OOD detection rule configuration is included with the machine learning model configuration 215). Additionally or alternatively, machine learning model configuration 215 may solely include the task model (e.g., the OOD detection rule configuration is indicated separately). In some examples, machine learning model configuration 215 and OOD detection rule configuration 220 may be configured and signaled to UE 115-a via RRC signaling. Details on how OOD detection rule configuration 220 is signaled to UE 115-a is described in greater detail with reference to FIGS. 6A and 6B.

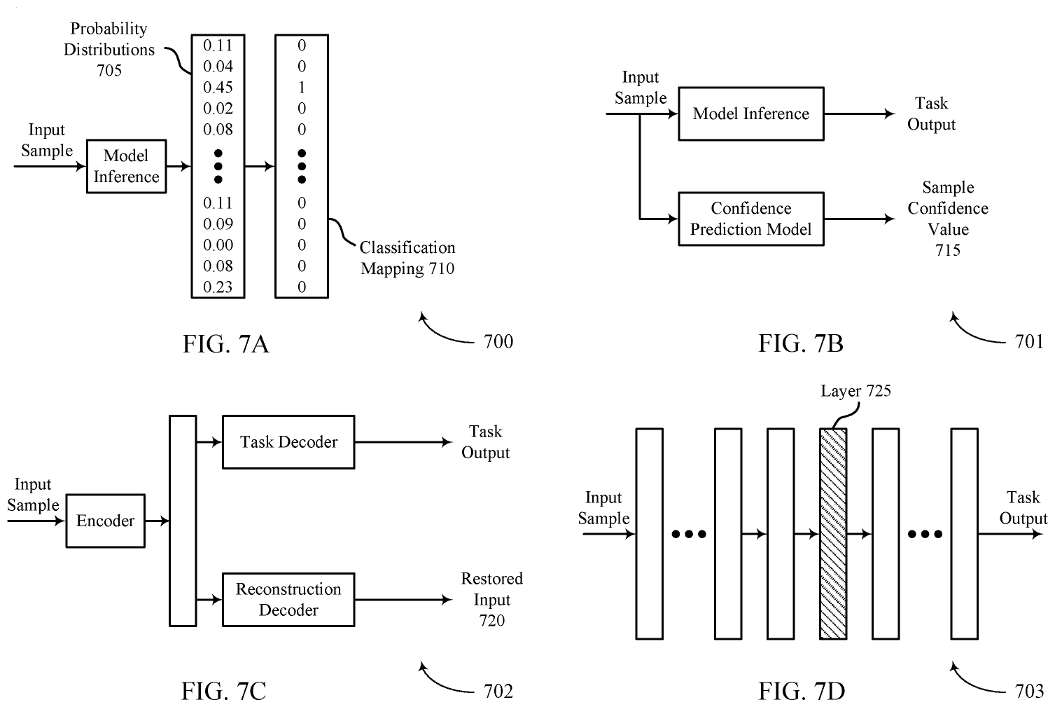

As part of a next step or operation of the procedure for detecting and reporting OOD events (e.g., a detect OOD event 225 operation), UE 115-a may detect an OOD event based on the set of OOD detection rules (e.g., indicated via OOD detection rule configuration 220). In some examples, UE 115-a may perform detect OOD event 225 to detect the OOD event to assist in monitoring a quality of samples (e.g., data samples) during a model inference procedure (e.g., using the machine learning model to predict outcomes for an application, where OOD events may cause the machine learning model to fail). In some examples, UE 115-a may perform detect OOD event 225 to detect the OOD event based on ranges or threshold values indicated by base station 105-a (e.g., with OOD detection rule configuration 220). For example, OOD detection rule configuration 220 may include rules for determining if a data sample falls outside of the machine learning model based on a probability distribution of outputs of the machine learning model (e.g., described in greater detail with reference to FIG. 7A), a confidence value of a given data sample (e.g., described in greater detail with reference to FIG. 7B), a reconstruction error of a generated model for a given data sample using the machine learning model (e.g., described in greater detail with reference to FIG. 7C), an FSD of an output of a latent feature for the machine learning model (e.g., described in greater detail with reference to FIG. 7D), or a combination thereof.

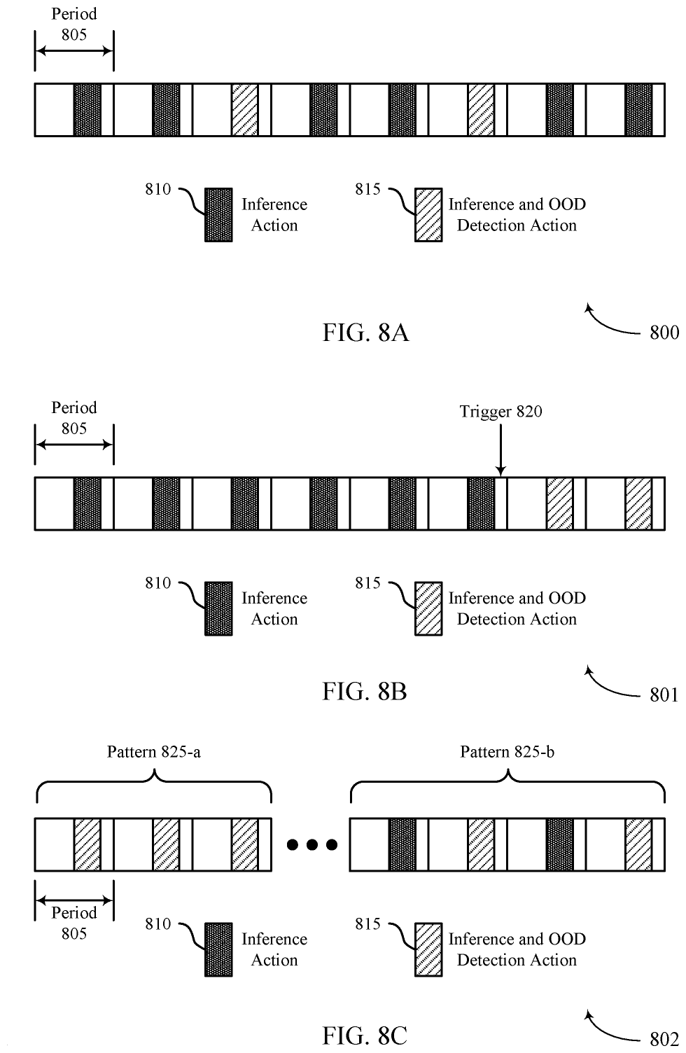

Additionally, in some examples, UE 115-a may detect whether data samples are OOD events (e.g., if the data samples fall outside of a dataset used to train the machine learning model) according to an OOD detection pattern indicated by base station 105-a. For example, base station 105-a may explicitly configure instances in time when UE 115-a is to monitor for and report OOD events (e.g., every ‘X’ number of slots, subframes, TTIs, etc.) or may transmit a trigger for UE 115-a to indicate when UE 115-a is to begin monitoring for and reporting the OOD events (e.g., subsequent to receiving the trigger). Additionally or alternatively, base station 105-a may implicitly configure the instances in time when UE 115-a is to monitor for and report OOD events based on one or more parameters. For example, based on parameters identified by UE 115-a, UE 115-a may determine an OOD detection pattern for monitoring for and reporting the OOD events using the implicit configuration. Details on how OOD detection patterns are signaled to or determined by UE 115-a is described in greater detail with reference to FIGS. 8A, 8B, and 8C.

Once an OOD event has been detected based on OOD detection rule configuration 220, as part of a next step or operation of the procedure for detecting and reporting OOD events, UE 115-a may transmit an OOD event indication 230 to base station 105-a (e.g., via carrier 210) to report the OOD event. In some example, the OOD detection triggering and reporting may be based on a downlink control information (DCI) indication, a MAC control element (CE), RRC signaling, or a combination thereof. When transmitting OOD event indication 230 after an OOD event has been detected, UE 115-a may report the OOD detection results. For example, reporting the OOD detection results may include two parts. A first part of the OOD detection results may include an indication of whether there is an OOD event for a sample (e.g., data sample). A second part of the OOD detection results may include a corresponding measurement value for the OOD event detection (e.g., values defined in the OOD detection rule configuration for UE 115-a to detect the OOD event, such as a probability distribution, a confidence value, a reconstruction error, an FSE, etc.). Accordingly, when transmitting OOD event indication 230, UE 115-a may report the indication of whether there is an OOD event, measurement values for the OOD event, or both.

In some examples, UE 115-a may determine to transmit OOD event indication 230 after an OOD event has been detected based on different options. For example, a first option for determining when to transmit OOD event indication 230 may include a first condition-based triggering, such that when there is an OOD event detected, UE 115-a may stop a task model application and may report the OOD event to base station 105-a (e.g., the network). Additionally or alternatively, another option for transmitting OOD event indication 230 may include a second condition-based triggering, such that when there is an OOD event detected, UE 115-a may report an output of the task model and a corresponding measurement value for the OOD event. Additionally or alternatively, another option for transmitting OOD event indication 230 may include following a pre-defined pattern. For example, base station 105-a may configure UE 115-a to perform an OOD detection and reporting (e.g., including reporting a measurement value) per a given number of slots (e.g., once every 10 slots). Additionally or alternatively, another option for transmitting OOD event indication 230 may include base station 105-a configuring UE 115-a to report a measurement of an OOD event detection (e.g., an explicit indication for UE 115-a to report the OOD event and any corresponding measurement values).

As described herein, OOD detection rule configuration 220 may include one or more signals to indicate a configuration for detecting a data sample that falls outside of a dataset used to train a machine learning model. For example, OOD detection rule configuration 220 include rules or methods on how UE 115-a is to identify OOD events (e.g., which measurements may correspond to OOD events). Additionally, OOD detection rule configuration 220 may include an OOD detection pattern that indicates when UE 115-a is to monitor for and detect OOD events. In some examples, OOD detection rule configuration 220 may also indicate how UE 115-a is to report an indication of an OOD event (e.g., a simple indication of whether the OOD event has occurred, with a corresponding measurement value for the OOD event, when to transmit the indication of the OOD event, or a combination thereof).

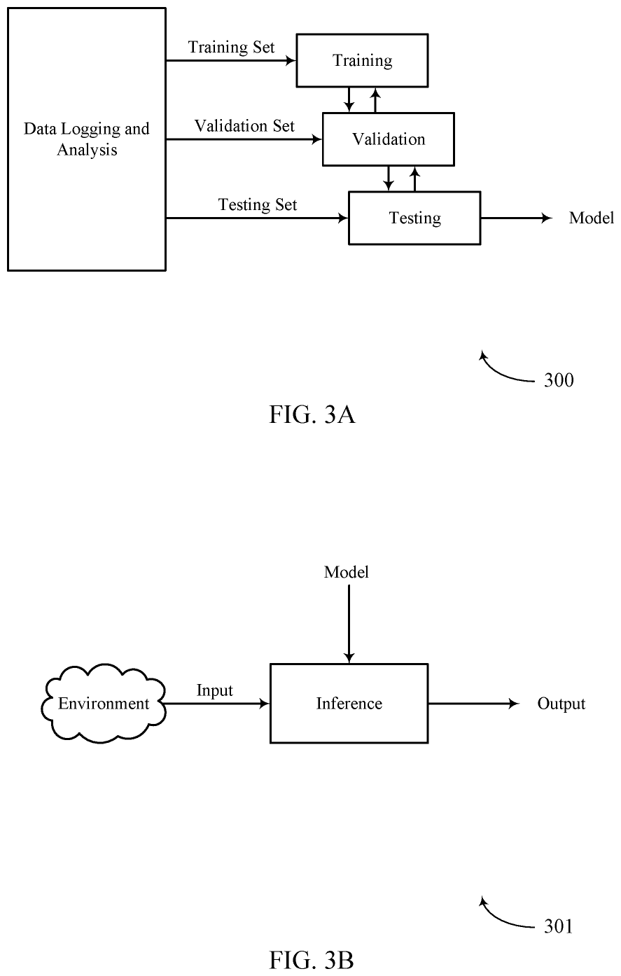

FIGS. 3A and 3B illustrate an example of a machine learning model preparation 300 and a machine learning model deployment 301, respectively, in accordance with aspects of the present disclosure. In some examples, machine learning model preparation 300 and machine learning model deployment 301 may implement aspects of or may be implemented by aspects of wireless communications system 100, wireless communications system 200, or both. For example, machine learning models may be prepared (e.g., by a base station 105, an additional network device, a UE 115, etc.) and then deployed on devices, such as UEs 115 as described with reference to FIGS. 1 and 2, for different applications (e.g., prediction, classification, compression, regression, or other targets). Accordingly, the machine learning models may be prepared based on machine learning model preparation 300 and then deployed based on machine learning model deployment 301.

Machine learning, especially deep machine learning, has become a popular tool in wireless communications systems to promote more efficient communications. For example, among other benefits, machine learning models deployed at a UE 115 may enable the UE 115 to make decisions or perform actions (e.g., using prediction or regression or other targets) without additional signaling from a base station 105 (e.g., the UE 115 can make an inference about an action to perform based on an input or detected event). Additionally, the machine learning models may enable the UE 115 to prepare transmissions for more efficient communications (e.g., using classification or compression or other targets). Before the machine learning models can be deployed on devices, the machine learning models may need to be prepared and trained (e.g., a using a dataset).

Machine learning model preparation 300 may represent a machine learning preparation procedure that includes training, validation, and testing stages. Each of the three (3) stages (e.g., training, validation, and testing) may depend on data logging and analysis. For example, the data logging and analysis may supply a training set of data (e.g., training dataset) for the training stage, where the training set of data is used to train the machine learning model. Additionally, the validation stage may use a validation set of data to ensure the machine learning model is performing as expected based on the training stage, and the testing stage may use a testing set of data to test the validated machine learning model. Each of the stages may build off each other (e.g., if the validation stage indicates an error occurs with the training stage, the training stage may be performed again). Because each stage pulls a set of data or different sets of data from the data logging and analysis, a quality of the logged data may determine a performance of the machine learning model (e.g., more accurate logged data may correspond to a more accurate machine learning model performing how the device expects, and less accurate logged data may correspond to unpredictable outcomes for the machine learning model).

Machine learning model deployment 301 may represent a deployment of the machine learning model. For example, the machine learning model may be deployed on a device to enable the device to make an inference based on inputs from an environment (e.g., real-world application, real-world environment, realistic environment, etc.) to produce an output. That is, the machine learning model is deployed in the device for the inference, where the output may include a classification, a prediction, compression, or others and the input is data from a realistic application environment. The training, validation, and testing stages of machine learning model preparation 300 described with reference to FIG. 3A may be based on a pre-logged dataset, while machine learning model deployment 301 uses real-time data from a realistic environment. As such, the real-time data may include anomalies or data samples that fall outside of the pre-logged dataset, resulting in OOD events. The techniques described herein may enable a device to detect and report OOD events.

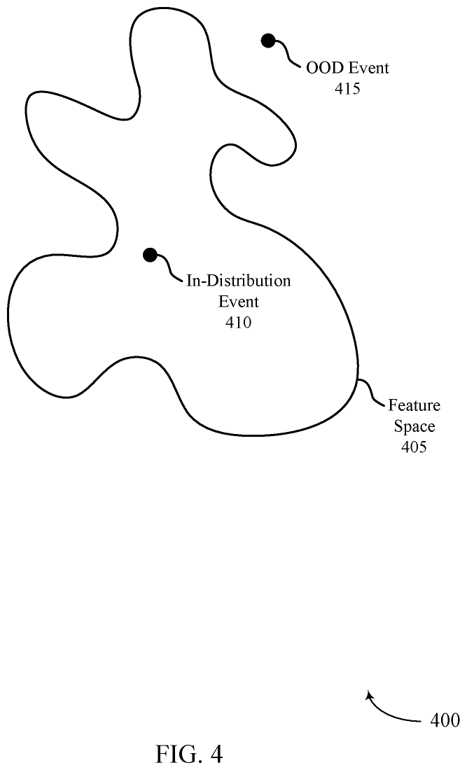

FIG. 4 illustrates an example of a distribution 400 in accordance with aspects of the present disclosure. In some examples, distribution 400 may implement aspects of or may be implemented by aspects of wireless communications system 100, wireless communications system 200, or both. For example, machine learning models may be prepared (e.g., by a base station 105, an additional network device, a UE 115, etc.) and then deployed on devices, such as UEs 115 as described with reference to FIGS. 1-3B, for different applications (e.g., prediction, classification, compression, regression, or other targets). Accordingly, the machine learning model may be valid for a dataset used to train the machine learning model, where inputs that fall within the dataset are referred to as in-distribution events and inputs that fall outside of the data set are referred to as OOD events. Efficient techniques are desired for detecting and reporting OOD events.

In some cases, deep learning algorithms (e.g., machine learning) may be generally considered as data-driven solutions. Additionally, the quality of data used to prepare and train the deep learning algorithms may determine a performance of an application (e.g., downlink application) for the deep learning algorithms on devices that machine learning is deployed (e.g., using the deep learning algorithms). The quality of the data may consist of an accuracy of the dataset (e.g., where the clear of the data can represent a feature of the dataset), a diversity of the dataset (e.g., where more data from all potential environments could provide robustness of the machine learning model in the deployment), or both. However, realistic deployment environments may be more complicated than expected environments, such that a prepared dataset used to train the machine learning model may not cover all potential scenarios or environments. In the machine learning model deployment, data from a new environment may be present, where this data from the new environment holds different features from the dataset used in the preparation and training of the machine learning model. Accordingly, this data from the new environment may be considered OOD compared to the previous logged dataset in the distribution for the machine learning model.

For example, as shown in the example of FIG. 4, distribution 400 may include a feature space 405 that corresponds to a dataset for which a machine learning model is applicable. In some examples, the feature space 405 may correspond to the dataset used in the preparation and training of the machine learning model, may include additional data outside of the dataset used in the preparation and training (e.g., the additional data may not be used to specifically train the machine learning model but the machine learning model may still be applicable for the additional data), or a combination thereof. Accordingly, an event (e.g., a data input, an input sample, a data sample, etc.) that falls within feature space 405 such that the machine learning model can be used to produce an outcome or inference for the event may be referred to as an in-distribution event 410. Additionally or alternatively, an event that falls outside of feature space 405 such that the machine learning model cannot be used to produce an expected outcome or inference may be referred to as an OOD event 415. In some example, OOD event 415 may be called a novelty, an outlier, or others.

When an OOD event is used as an input into a machine learning model (e.g., when meeting or detecting OOD data), the machine learning model may fail. However, OOD events are unavoidable, unknown (e.g., until detected or observed), and unpredictable. For example, a device may not detect an OOD event until the failure output of the machine learning model for the OOD event. Accordingly, OOD event may present a big challenge for deployments of machine learning models, such that detecting OOD events may provide benefits for deployment and training of the machine learning models. Different procedures may enable a device to detect OOD events.

In some example, a device may use a soft-max based solution to detect OOD events. For example, based on the pre-trained machine learning model, the device may compare a probability distribution of an output to determine whether an input used to produce that output is an in-distribution event or an OOD event. As part of the soft-max based solution, a threshold probability distribution value or range of probability distributions may be defined, where a probability distribution of an output is compared to the threshold value or range to determine whether an input (e.g., data sample) is an in-distribution event or an OOD event. The machine learning model may also fit for a soft-max loss function and may not need to modify the machine learning model.

Additionally or alternatively, a device may use an uncertainty solution to detect OOD events. The uncertainty solution may not be directly based on the probability but may depend on a confidence of an output of the machine learning model generated from an input sample. If a data uncertainty is high for the output of the machine learning model, the input sample may be considered as an OOD event. By using the uncertainty solution, an accuracy of OOD detection may be high, but the uncertainty solution may rely on a single specific model to predict the confidence.

Additionally or alternatively, a device may use a generative model to detect OOD events. In an auto-encoder structure, a reconstruction error or other metrics may determine whether an input sample (e.g., data sample) is an in-distribution event or an OOD event. An encoder block may learn a latent space of the input sample for in-distribution events, but for OOD events, a reconstruction of error for the input sample may be large. Accordingly, the generative model may use a threshold value for a metric (e.g., reconstruction error threshold) to determine whether an input sample is an in-distribution event or an OOD event.

Additionally or alternatively, a device may use a feature space representation to detect OOD events. For example, using the feature space representation, the device may analyze an FSD of some inner layer output for the machine learning model. If the inner feature is out of a feature space (e.g., feature space 405) for the machine learning model, the device may determine an input sample that results in the FSD of the inner layer output falling out of the feature space to be an OOD event. Additional techniques and procedures may be used to detect OOD events that are expressly listed herein.

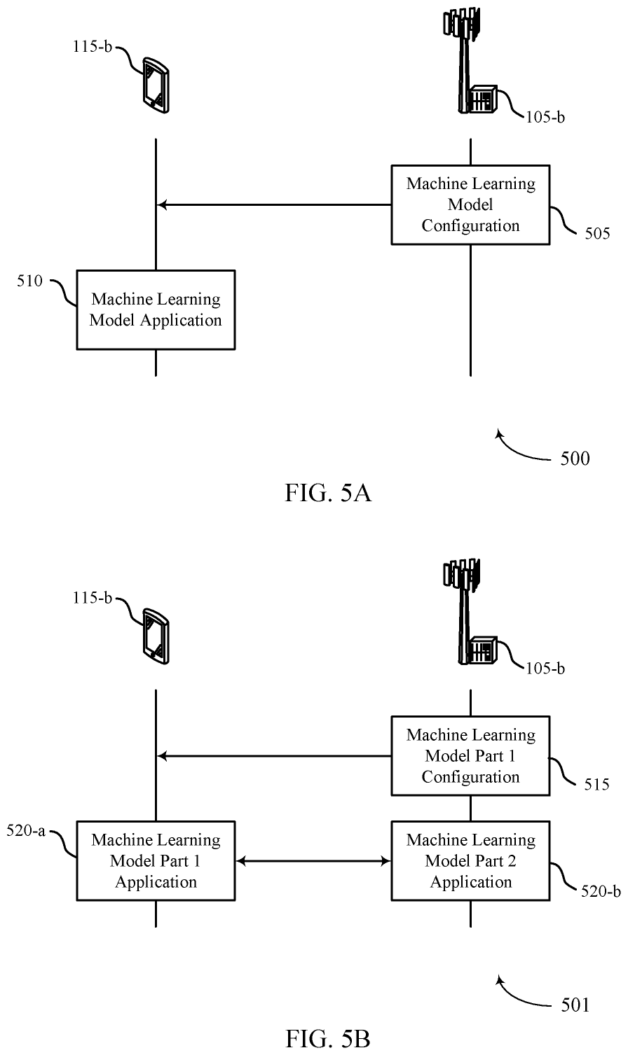

FIGS. 5A and 5B illustrate examples of a machine learning application 500 and a machine learning application 501, respectively, in accordance with aspects of the present disclosure. In some examples, machine learning application 500 and machine learning application 501 may implement aspects of or may be implemented by aspects of wireless communications system 100, wireless communications system 200, or both. For example, machine learning application 500 and machine learning application 501 may include a base station 105-b and a UE 115-b, which may represent examples of corresponding base stations 105 and UEs 115, respectively, as described with reference to FIGS. 1-4. Additionally, machine learning models may be prepared (e.g., by base station 105-b, an additional network device, a UE 115, etc.) and then deployed on devices, such as UE 115-b, for different applications (e.g., prediction, classification, compression, regression, or other targets).

In some examples, machine learning applications in wireless communications systems have become popular to replace or optimize communication blocks. Additionally, the machine learning applications may be classified into two options: a network configuration with an independent model application on the UE side, or a network configuration with a joint model application between a base station 105 and a UE 115.

Machine learning application 500 may represent the option where a machine learning model is a network configuration with independent model application for the machine learning model at the UE side. For example, at 505, base station 105-b may determine a machine learning model configuration (e.g., prepared as described with reference to FIG. 3A) and may indicate this machine learning model configuration to UE 115-b for the machine learning model configuration to be deployed on UE 115-b (e.g., deployed as described with reference to FIG. 3B). At 510, UE 115-b may then use the received machine learning model configuration for an application based on the machine learning model. In the example of machine learning application 500, an output of the machine learning mode may be fed back to base station 105-b or applied in the UE side.

Additionally or alternatively, machine learning application 501 may represent the option where a machine learning model is a network configuration with a joint model application between a base station 105 and a UE 115. For example, the machine learning model may include two parts as part of a joint model. At 515, base station 105-b may determine a first part of a machine learning model configuration and may indicate this first part to UE 115-b. At 520, UE 115-b and base station 105-b may then use the joint model application. For example, at 520-a, UE 115-b may use the received first part of the machine learning model configuration for an application. Additionally, UE 115-b may feedback the outputs (e.g., latent) for the first part of the machine learning model to base station 105-b. At 520-b, base station 105-b may use the feedback for the first part to generate or run a second part of the machine learning model application.

As described herein, OOD events may impact both machine learning application 500 and machine learning application 501. As such, the techniques described herein for detecting and reporting OOD events may be used for both machine learning application 500 and machine learning application 501.

FIGS. 6A and 6B illustrate examples of an OOD detection model indication 600 and an OOD detection model indication 601, respectively, that support OOD detection and reporting for machine learning model deployment in accordance with aspects of the present disclosure. In some examples, OOD detection model indication 600 and OOD detection model indication 601 may implement aspects of or may be implemented by aspects of wireless communications system 100, wireless communications system 200, or both. For example, machine learning models may be prepared (e.g., by a base station 105, an additional network device, a UE 115, etc.) and then deployed on devices, such as UEs 115 as described with reference to FIGS. 1-5B, for different applications (e.g., prediction, classification, compression, regression, or other targets). Additionally, as described herein and with reference to FIG. 2, the devices on which the machine learning model is deployed may detect OOD events based on an OOD detection rule configuration indicated by a network device that prepares the machine learning model (e.g., a base station 105). That is, the network device may configure OOD detection on the UE side.

In some examples, OOD detection model indication 600 may represent a configuration for configuring OOD detection rules and indicating such a configuration to a UE 115 that uses a specific model that is configured for the OOD detection. For example, in OOD detection model indication 600, the network device may indicate a first configuration for the machine learning model and associated tasks for the machine learning model (e.g., channel state information (CSI) estimation) and may indicate a second configuration for an additional model for the OOD detection (e.g., OOD detection rule configuration). Accordingly, a same input sample (e.g., data sample) may be fed into each configuration to produce respective outputs. For example, the input sample may result in a task output for the machine learning model based on a model inference corresponding to the machine learning model. Additionally or alternatively, the input sample may be fed into the OOD detection model and may result in an OOD indication for the input sample.

Additionally or alternatively, OOD detection model indication 601 may represent an OOD detection that is embedded in the machine learning model for a given task. That is, the network device may indicate a single configuration to the device to indicate both a machine learning model configuration and an OOD detection rule configuration. Accordingly, a same input sample may be fed into the single configuration that then generates both a task output based on an inference for the machine learning model and an OOD event indication. For example, the OOD detection may be based on a confidence of the output in the task model.

In some examples, the network device may configure the OOD detection rules to the device (e.g., UE 115). Based on these rules, the device may determine whether an input sample (e.g., data sample) is an OOD event or not. In some examples, the rules for the OOD detection may be configured jointly with a configuration for the machine learning model. Additionally or alternatively, the rules for the OOD detection may be a common configuration for one series of a set of machine learning models, where the device receives the common configuration previously (e.g., via higher layer signaling) or the device may be preconfigured with the common configuration.

FIGS. 7A, 7B, 7C, and 7D illustrate examples of an OOD detection configuration 700, an OOD detection configuration 701, an OOD detection configuration 702, and an OOD detection configuration 703, respectively, that support OOD detection and reporting for machine learning model deployment in accordance with aspects of the present disclosure. In some examples, OOD detection configuration 700, OOD detection configuration 701, OOD detection configuration 702, and OOD detection configuration 703 may implement aspects of or may be implemented by aspects of wireless communications system 100, wireless communications system 200, or both. For example, as described herein, to support a machine learning model deployment on a UE 115 (e.g., or a different device), a base station 105 (e.g., or an additional network device) may indicate an OOD detection rule configuration to the UE 115 for the UE 115 to detect OOD event for the machine learning model. In some examples, the OOD detection rule configuration may include rules on how the UE 115 determines whether an input sample corresponds to an OOD event or not (e.g., the OOD detection rule configuration includes a method for the OOD event detection and corresponding metrics to identify the OOD events).

OOD detection configuration 700 may represent a first option for detecting OOD events based on probability distributions of outputs for the machine learning model. In the OOD detection rule configuration, the base station 105 may configure a procedure of a probability calculation (e.g., based on a softmax function as described with reference to FIG. 4). The base station 105 may configure an acceptable probability distribution range, given by gamma (γ). Accordingly, when a probability distribution for an input sample falls outside of the acceptable probability distribution range (e.g., gamma), the UE 115 may determine the input sample is an OOD event. For example, as shown, one or more data samples (e.g., input sample) may be input to the machine learning model to generate inferences for the one or more data samples. Each of the one or more data samples may then correspond to an individual probability distribution value of a set of probability distributions 705. Based on the configured acceptable probability distribution range, the UE 115 may then generate a classification mapping 710 to indicate which input samples had a probability distribution outside of the acceptable probability distribution range. For example, a third data sample may have a probability distribution of ‘0.45’ that falls outside of the configured acceptable probability distribution range, such that the UE 115 indicates a ‘1’ for that corresponding data sample in the classification mapping 710 to indicate that the third data sample is an OOD event.

OOD detection configuration 701 may represent an additional option for detecting OOD events based on a confidence value of a given input sample. In the OOD detection rule configuration, the base station 105 may configure a method to calculate a confidence for an input sample (e.g., based on one specific model). Additionally, the base station 105 may configure an acceptable confidence value threshold, given by gamma (γ). When the confidence value of the input sample is less than (e.g., does not satisfy) the acceptable confidence value threshold (e.g., gamma), the UE 115 may determine the input sample is an OOD event. For example, as shown, an input sample may be fed into the machine learning model to produce a task output based on an inference corresponding to the machine learning model and may be fed into a confidence prediction model (e.g., indicated with the OOD detection rule configuration) to produce a sample confidence value 715 for the input sample. Accordingly, if the sample confidence value 715 does not satisfy the acceptable confidence value threshold, the UE 115 may determine the corresponding input sample is an OOD event (e.g., the sample confidence value 715 may be ‘0.2’ which may be less than the acceptable confidence value threshold, resulting in the corresponding input sample being determined to be an OOD event).

OOD detection configuration 702 may represent an additional option for detecting OOD events based on a reconstruction error in a generative model of an input sample (e.g., data sample). In the OOD detection rule configuration, the base station 105 may configure the generative model and a method to calculate the reconstruction error (e.g., a mean-squared error (MSE) measure and calculation). Additionally, the base station 105 may configure an acceptable reconstruction error threshold, given by gamma (γ). When a reconstruction error of an input sample is larger than the acceptable reconstruction error threshold (e.g., gamma), the UE 115 may determine the input sample is an OOD event. For example, as shown, an input sample may be fed into an encoder, where a task decoder for the machine learning model may produce a task output for the input sample. In some examples, the task decoder may be part of a machine learning model for performing a task. Additionally, the encoded input sample may go through a reconstruction decoder (e.g., indicated with the OOD detection rule configuration) to produce a restored input 720. In some examples, the reconstruction decoder may be part of a generative model for OOD detection. The restored input 720 may be compared against the actual input sample to determine a reconstruction error for the input sample, where if the reconstruction error does not satisfy the acceptable reconstruction error threshold (e.g., the reconstruction error is higher than the acceptable reconstruction error threshold), the UE 115 determines the input sample is an OOD event.

OOD detection configuration 703 may represent an additional option for detecting OOD events based on a latent FSD of an output in one layer of the machine learning model. In the OOD detection rule configuration, the base station 105 may configure a location of an output of a latent feature (e.g., a layer 725) of the machine learning model. Additionally, the base station 105 may configure an acceptable FSD range, given by gamma (γ). When the FSD for an input sample (e.g., data sample) at the indicated layer is outside of the acceptable FSD range (e.g., gamma), the UE 115 may determine the input sample is an OOD event. For example, as shown, the base station 105 may indicate a location of a layer 725 of the machine learning model. The UE 115 may take an output for an input sample at the layer 725 and may compare a latent FSD of the output at the layer 725 to the acceptable FSD range. If the latent FSD falls outside of the acceptable FSD range, the UE 115 may determine the input sample corresponds to an OOD event. While these different options for detecting OOD events are described, additional options may be used for detecting OOD events not described herein.

FIGS. 8A, 8B, and 8C illustrate examples of an OOD detection pattern 800, an OOD detection pattern 801, and an OOD detection pattern 802, respectively, that support OOD detection and reporting for machine learning model deployment in accordance with aspects of the present disclosure. In some examples, OOD detection pattern 800, OOD detection pattern 801, and OOD detection pattern 802 may implement aspects of or may be implemented by aspects of wireless communications system 100, wireless communications system 200, or both. For example, as described herein, to support a machine learning model deployment on a UE 115 (e.g., or a different device), a base station 105 (e.g., or an additional network device) may indicate an OOD detection rule configuration to the UE 115 for the UE 115 to detect OOD event for the machine learning model. In some examples, the OOD detection rule configuration may include indications of instances in time where the UE 115 is to monitor for and detect OOD events. For example, the base station 105 may transmit an indication of an OOD detection pattern that includes when the UE 115 is to monitor for and detect OOD events.

In some examples, if there is one specific model for OOD detection, the base station 105 may configure the OOD detection pattern. That is, the base station 105 may configure an OOD detection model (e.g., OOD detection rule configuration) and corresponding rules. For example, the OOD detection model may be pre-trained for a confidence prediction of an input sample, such that if an output confidence is low for a given input sample, that given input sample may be considered an OOD event. Additionally, the base station 105 may configure an OOD detection pattern for the UE 115, where the OOD detection pattern includes one or more periods 805 when the UE 115 monitors for and detects OOD events. For example, the OOD detection pattern may include one or more periods 805 configured for inference actions 810 (e.g., using the machine learning model to make an inference for an input sample, such as a data sample) and one or more periods 805 for inference and OOD detection actions 815 (e.g., using the machine learning model to make an inference for an input sample and using the OOD detection model to determine whether the input sample is an OOD event or not).

OOD detection pattern 800 may represent a first option for a configuration of a detection pattern that includes a fixed periodical format. For example, as shown, the fixed periodical format may include a configuration where the UE 115 performs an inference and OOD detection action 815 every three (3) periods 805 (e.g., different length TTIs, such as slots, subframes, subslots, etc.). Fixed period formats longer than three (3) periods 805 or shorter than three (3) periods 805 may be used for the OOD detection pattern. In some examples, the base station 105 may configure the fixed period for performing the inference and OOD detection action 815 with the OOD detection model (e.g., the OOD detection rule configuration).

OOD detection pattern 801 may represent an additional option for a configuration of a detection pattern that is explicitly indicated by the base station 105. For example, based on a performance of the machine learning model as indicated by outputs of one or more inference actions 810, the base station 105 may transmit a trigger 820 that triggers the OOD detection for the UE 115. For example, after receiving the trigger 820, the UE 115 may then perform an inference and OOD detection action 815 for subsequent periods 805 (e.g., for a set number of periods 805, until an indication to stop performing the OOD detection is received, or another number of periods 805).

OOD detection pattern 801 may represent an additional option for a configuration of a detection pattern that is implicitly configured by some parameters indicated by the base station 105, where the UE 115 determines which OOD detection pattern to apply based on observed parameters. For example, the base station 105 may indicate multiple OOD detection patterns (e.g., with the OOD detection rule configuration) and associated parameters for each OOD detection pattern. Subsequently, the UE 115 may then select one of the multiple OOD detection patterns for performing inference and OOD detection actions 815 based on parameters observed for communications between the UE 115 and the base station 105. For parameters that correspond to frequent environment variations, the UE 115 may select an OOD detection pattern with a high density of inference and OOD detection actions 815. For example, as shown, the UE 115 may select a pattern 825-a when the observed parameters correspond to frequent environment variations (e.g., a high doppler environment) such that an inference and OOD detection action 815 occurs in each period 805. Additionally or alternatively, the UE 115 may select a pattern 825-b with fewer configured inference and OOD detection actions 815 (e.g., every other period 805) when the observed parameters correspond to a more static environment and less variations (e.g., a low doppler environment).

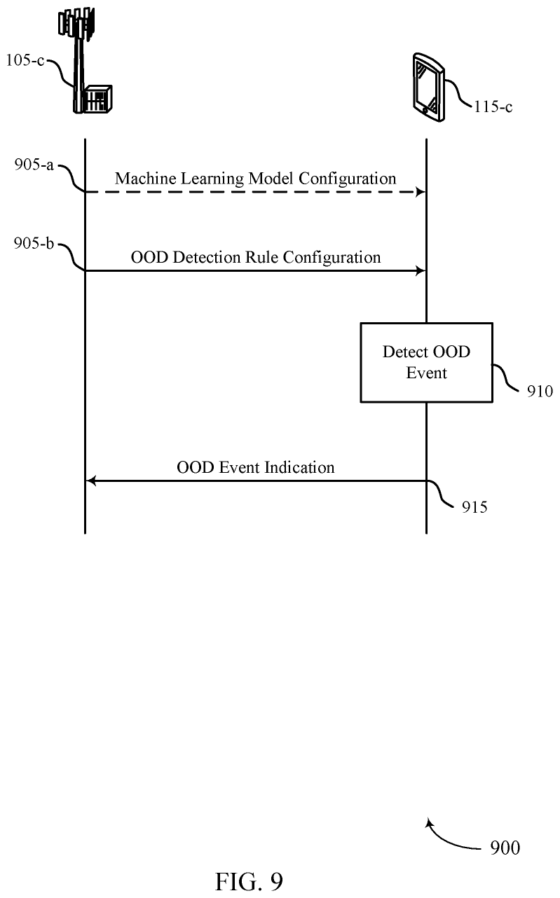

FIG. 9 illustrates an example of a process flow 900 that supports OOD detection and reporting for machine learning model deployment in accordance with aspects of the present disclosure. In some examples, process flow 900 may implement aspects of or may be implemented by aspects of wireless communications system 100, wireless communications system 200, or both. For example, process flow 900 may include a base station 105-c and a UE 115-c, which may represent examples of corresponding base stations 105 and UEs 115, respectively, as described with reference to FIGS. 1-8C.

In the following description of process flow 900, the operations between UE 115-c and base station 105-c may be performed in different orders or at different times. Certain operations may also be left out of process flow 900, or other operations may be added to process flow 900. It is to be understood that while UE 115-c and base station 105-c are shown performing a number of the operations of process flow 900, any wireless device may perform the operations shown.

At 905, UE 115-c may receive, from base station 105-c, control signaling indicating an OOD detection rule configuration for detecting a data sample that falls outside of a dataset used to train a first machine learning model. For example, at 905-a, UE 115-a may receive, from base station 105-c, the control signaling that indicates a model configuration for configuring the first machine learning model to generate the at least one data sample. Additionally, at 905-b, UE 115-c may receive, from base station 105-c, the control signaling that indicates the OOD detection rule configuration for configuring a second machine learning model for detecting data samples that fall outside of the dataset used to train the first machine learning model. Additionally or alternatively, UE 115-c may receive, from base station 105-c, the control signaling that indicates a model configuration for configuring the first machine learning model to generate the at least one data sample and to detect data samples that fall outside of the dataset used to train the first machine learning model.

In some examples, UE 115-c may receive the control signaling that jointly configures UE 115-c with the OOD detection rule configuration and a model configuration for the first machine learning model. Additionally or alternatively, UE 115-c may receive the control signaling that indicates the OOD detection rule configuration that is a common OOD detection rule configuration for multiple machine learning models.

Additionally, in some examples, UE 115-c may receive the control signaling indicating the OOD detection rule configuration that indicates an OOD detection pattern to enable UE 115-c to monitor for and detect OOD events. For example, the OOD detection pattern may indicate a fixed period of instances for UE 115-c to determine whether one or more data samples generated by the first machine learning model fall outside of the dataset used to train the first machine learning model (e.g., as described with reference to FIG. 8A). Additionally or alternatively, the OOD detection pattern may indicate specific instances for UE 115-c to determine whether one or more data samples generated by the first machine learning model fall outside of the dataset used to train the first machine learning model (e.g., as described with reference to FIG. 8B). In some examples, UE 115-c may receive the control signaling indicating the OOD detection rule configuration that indicates one or more parameters to implicitly indicate an OOD detection pattern (e.g., as described with reference to FIG. 8C).

At 910, UE 115-c may determine that an OOD detection event has occurred based on determining that at least one data sample generated by the first machine learning model falls outside of the dataset based on the OOD detection rule configuration. In an example, UE 115-c may operate a model inference that perform OOD detection in accordance with the OOD detection rule configuration. In some examples, the control signaling indicating the OOD detection rule configuration may indicate a probability distribution range for a probability distribution for data samples generated by the first machine learning model, where the at least one data sample is determined to fall outside of the dataset based on the at least one data sample falling outside of the probability distribution range (e.g., as described with reference to FIG. 7A). Additionally or alternatively, the control signaling indicating the OOD detection rule configuration may indicate a confidence value threshold for the first machine learning model, where the at least one data sample is determined to fall outside of the dataset based on the at least one data sample satisfying the confidence value threshold (e.g., as described with reference to FIG. 7B).

In some examples, the control signaling indicating the OOD detection rule configuration may indicate a reconstruction error threshold for the first machine learning model, where the at least one data sample is determined to fall outside of the dataset based on the at least one data sample satisfying the reconstruction error threshold (e.g., as described with reference to FIG. 7C). Additionally or alternatively, the control signaling indicating the OOD detection rule configuration may indicate an FSD range and a latent feature location for the first machine learning model, where the at least one data sample is determined to fall outside of the dataset based on the at least one data sample falling outside of the FSD range relative to the latent feature location (e.g., as described with reference to FIG. 7D).

At 915, UE 115-c may transmit, to base station 105-c, an indication that the OOD detection event has been determined for the at least one data sample. In some examples, UE 115-c may transmit the indication that indicates a measurement value for the at least one data sample (e.g., probability distribution value, confidence value, reconstruction error value, FSD value, etc.). Additionally, UE 115-c may transmit the indication that the OOD detection event has been determined based on a reporting trigger condition being satisfied, a pre-defined reporting pattern, a reporting configuration, or a combination thereof.

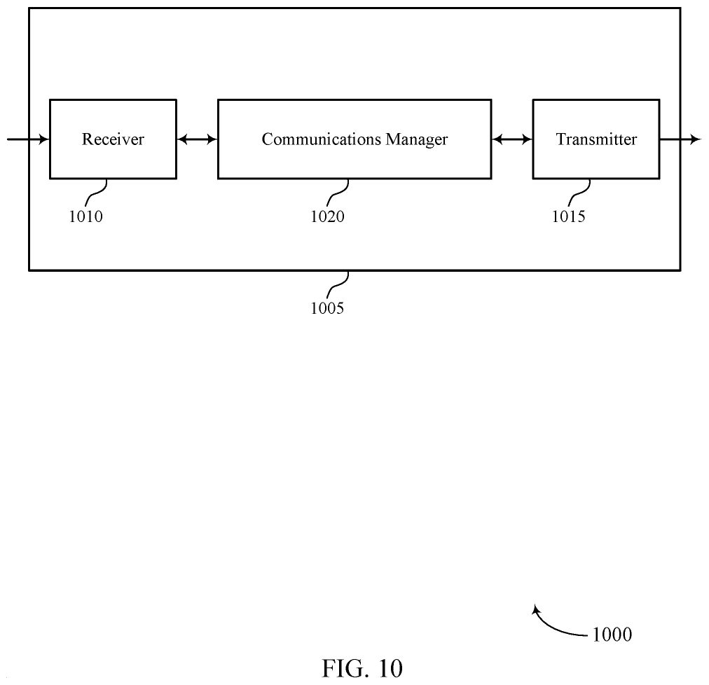

FIG. 10 shows a block diagram 1000 of a device 1005 that supports OOD detection and reporting for machine learning model deployment in accordance with aspects of the present disclosure. The device 1005 may be an example of aspects of a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to OOD detection and reporting for machine learning model deployment). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to OOD detection and reporting for machine learning model deployment). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of OOD detection and reporting for machine learning model deployment as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a UE in accordance with examples as disclosed herein. For example, the communications manager 1020 may be configured as or otherwise support a means for receiving, from a base station, control signaling indicating an OOD detection rule configuration for detecting a data sample that falls outside of a dataset used to train a first machine learning model. The communications manager 1020 may be configured as or otherwise support a means for determining that an OOD detection event has occurred based on determining that at least one data sample generated by the first machine learning model falls outside of the dataset based on the OOD detection rule configuration. The communications manager 1020 may be configured as or otherwise support a means for transmitting, to the base station, an indication that the OOD detection event has been determined for the at least one data sample.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for reduced processing, reduced power consumption, and more efficient utilization of communication resources. For example, the described techniques may enable the device 1005 to more accurately perform and update a machine learning model based on detecting and reporting OOD events. The machine learning model itself may support applications at the device 1005 (e.g., prediction, classification, compression, regression, or other targets) that then improve communications (e.g., reduced processing, reduced power consumption, more efficient utilization of communication resources, etc.) for the device 1005. Accordingly, the described techniques may improve machine learning models, which in turn provide a number of improvements and advantages at the device 1005.

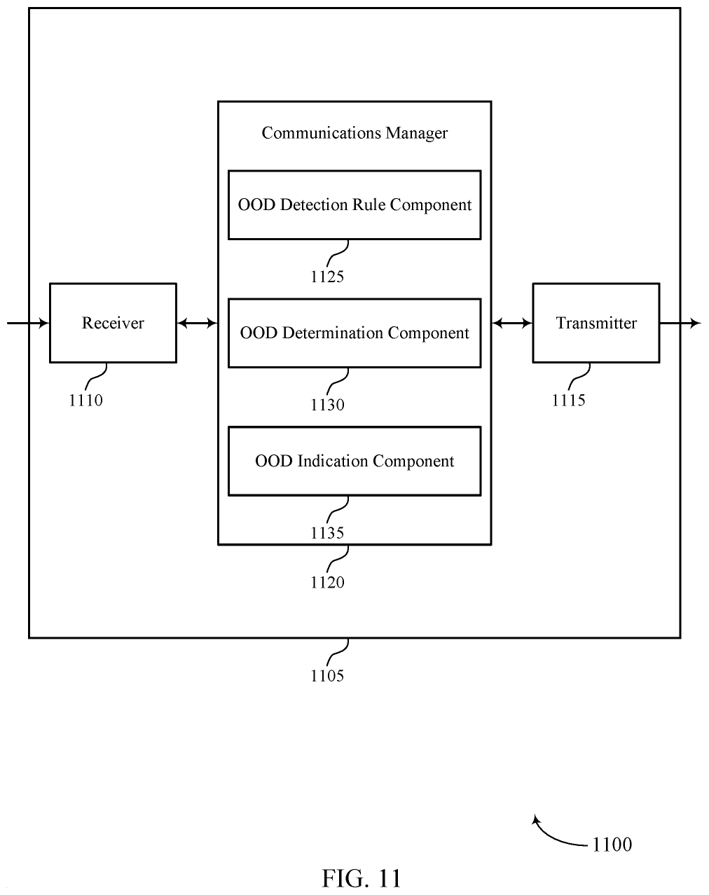

FIG. 11 shows a block diagram 1100 of a device 1105 that supports OOD detection and reporting for machine learning model deployment in accordance with aspects of the present disclosure. The device 1105 may be an example of aspects of a device 1005 or a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to OOD detection and reporting for machine learning model deployment). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to OOD detection and reporting for machine learning model deployment). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of OOD detection and reporting for machine learning model deployment as described herein. For example, the communications manager 1120 may include a OOD detection rule component 1125, a OOD determination component 1130, a OOD indication component 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communications at a UE in accordance with examples as disclosed herein. The OOD detection rule component 1125 may be configured as or otherwise support a means for receiving, from a base station, control signaling indicating an OOD detection rule configuration for detecting a data sample that falls outside of a dataset used to train a first machine learning model. The OOD determination component 1130 may be configured as or otherwise support a means for determining that an OOD detection event has occurred based on determining that at least one data sample generated by the first machine learning model falls outside of the dataset based on the OOD detection rule configuration. The OOD indication component 1135 may be configured as or otherwise support a means for transmitting, to the base station, an indication that the OOD detection event has been determined for the at least one data sample.

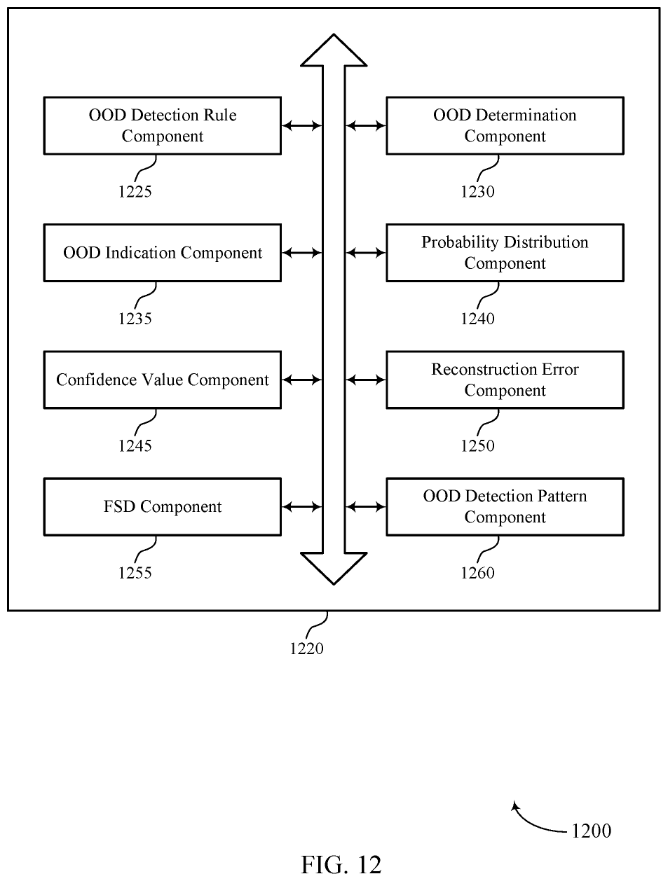

FIG. 12 shows a block diagram 1200 of a communications manager 1220 that supports OOD detection and reporting for machine learning model deployment in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of OOD detection and reporting for machine learning model deployment as described herein. For example, the communications manager 1220 may include a OOD detection rule component 1225, a OOD determination component 1230, a OOD indication component 1235, a probability distribution component 1240, a confidence value component 1245, a reconstruction error component 1250, an FSD component 1255, a OOD detection pattern component 1260, or any combination thereof. Each of these components may communicate, directly or indirectly, with one another (e.g., via one or more buses).

The communications manager 1220 may support wireless communications at a UE in accordance with examples as disclosed herein. The OOD detection rule component 1225 may be configured as or otherwise support a means for receiving, from a base station, control signaling indicating an OOD detection rule configuration for detecting a data sample that falls outside of a dataset used to train a first machine learning model. The OOD determination component 1230 may be configured as or otherwise support a means for determining that an OOD detection event has occurred based on determining that at least one data sample generated by the first machine learning model falls outside of the dataset based on the OOD detection rule configuration. The OOD indication component 1235 may be configured as or otherwise support a means for transmitting, to the base station, an indication that the OOD detection event has been determined for the at least one data sample.

In some examples, to support receiving the control signaling, the OOD detection rule component 1225 may be configured as or otherwise support a means for receiving, from the base station, the control signaling that indicates a model configuration for configuring the first machine learning model to generate the at least one data sample and that indicates the OOD detection rule configuration for configuring a second machine learning model for detecting data samples that fall outside of the dataset used to train the first machine learning model.

In some examples, to support receiving the control signaling, the OOD detection rule component 1225 may be configured as or otherwise support a means for receiving, from the base station, the control signaling that indicates a model configuration for configuring the first machine learning model to generate the at least one data sample and detect data samples that fall outside of the dataset used to train the first machine learning model.

In some examples, to support receiving the control signaling, the OOD detection rule component 1225 may be configured as or otherwise support a means for receiving the control signaling that jointly configures the UE with the OOD detection rule configuration and a model configuration for the first machine learning model.

In some examples, to support receiving the control signaling, the OOD detection rule component 1225 may be configured as or otherwise support a means for receiving the control signaling that indicates the OOD detection rule configuration that is a common OOD detection rule configuration for a set of multiple machine learning models.

In some examples, to support receiving the control signaling, the probability distribution component 1240 may be configured as or otherwise support a means for receiving the control signaling indicating the OOD detection rule configuration that indicates a probability distribution range for a probability distribution for data samples generated by the first machine learning model.

In some examples, to support transmitting the indication that the OOD detection event has been determined, the probability distribution component 1240 may be configured as or otherwise support a means for transmitting the indication based on the at least one data sample falling outside of the probability distribution range.

In some examples, to support receiving the control signaling, the confidence value component 1245 may be configured as or otherwise support a means for receiving the control signaling indicating the OOD detection rule configuration that indicates a confidence value threshold for the first machine learning model.

In some examples, to support transmitting the indication that the OOD detection event has been determined, the confidence value component 1245 may be configured as or otherwise support a means for transmitting the indication based on the at least one data sample satisfying the confidence value threshold.

In some examples, to support receiving the control signaling, the reconstruction error component 1250 may be configured as or otherwise support a means for receiving the control signaling indicating the OOD detection rule configuration that indicates a reconstruction error threshold for the first machine learning model.

In some examples, to support transmitting the indication that the OOD detection event has been determined, the reconstruction error component 1250 may be configured as or otherwise support a means for transmitting the indication based on the at least one data sample satisfying the reconstruction error threshold.

In some examples, to support receiving the control signaling, the FSD component 1255 may be configured as or otherwise support a means for receiving the control signaling indicating the OOD detection rule configuration that indicates a FSD range and a latent feature location for the first machine learning model.

In some examples, to support transmitting the indication that the OOD detection event has been determined, the FSD component 1255 may be configured as or otherwise support a means for transmitting the indication based on the at least one data sample falling outside of the FSD range relative to the latent feature location.

In some examples, to support receiving the control signaling, the OOD detection pattern component 1260 may be configured as or otherwise support a means for receiving the control signaling indicating the OOD detection rule configuration that indicates an OOD detection pattern, where the at least one data sample is determined to fall outside of the dataset according to the OOD detection pattern.

In some examples, the OOD detection pattern indicates a fixed period of instances for the UE to determine whether one or more data samples generated by the first machine learning model fall outside of the dataset used to train the first machine learning model.

In some examples, the OOD detection pattern indicates specific instances for the UE to determine whether one or more data samples generated by the first machine learning model fall outside of the dataset used to train the first machine learning model.

In some examples, the OOD detection pattern component 1260 may be configured as or otherwise support a means for receiving the control signaling indicating the OOD detection rule configuration that indicates one or more parameters to implicitly indicate an OOD detection pattern.

In some examples, to support transmitting the indication that the OOD detection event has been determined, the OOD indication component 1235 may be configured as or otherwise support a means for transmitting the indication that indicates a measurement value for the at least one data sample.

In some examples, to support transmitting the indication that the OOD detection event has been determined, the OOD indication component 1235 may be configured as or otherwise support a means for transmitting the indication that the OOD detection event has been determined based on a reporting trigger condition being satisfied, a pre-defined reporting pattern, a reporting configuration, or a combination thereof.

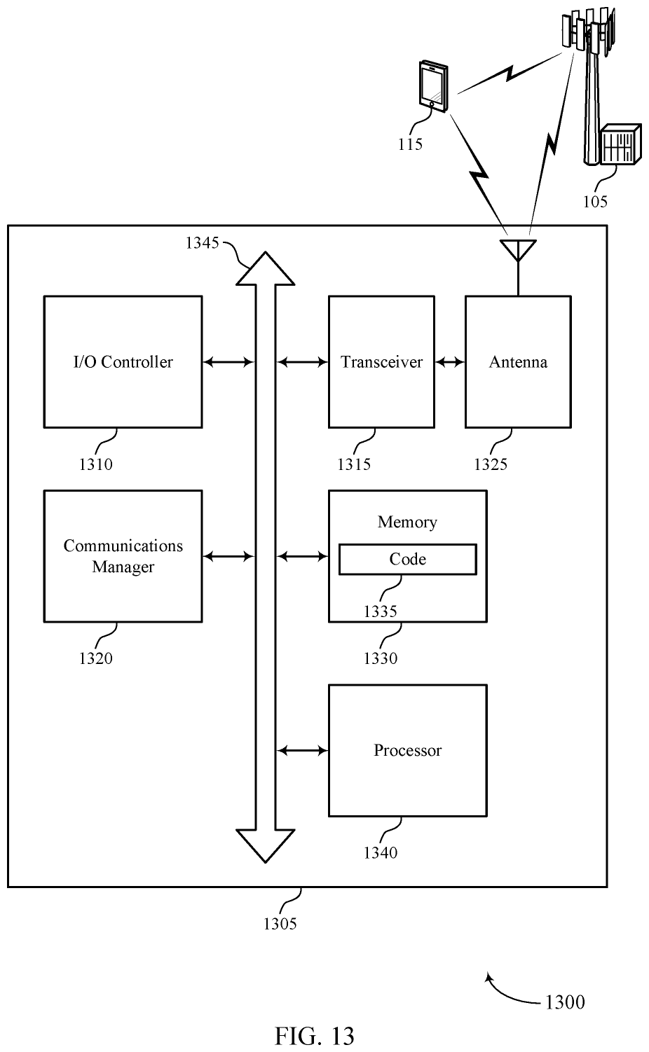

FIG. 13 shows a diagram of a system 1300 including a device 1305 that supports OOD detection and reporting for machine learning model deployment in accordance with aspects of the present disclosure. The device 1305 may be an example of or include the components of a device 1005, a device 1105, or a UE 115 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include random access memory (RAM) and read-only memory (ROM). The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a basic I/O system (BIOS) which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting OOD detection and reporting for machine learning model deployment). For example, the device 1305 or a component of the device 1305 may include a processor 1340 and memory 1330 coupled to the processor 1340, the processor 1340 and memory 1330 configured to perform various functions described herein.

The communications manager 1320 may support wireless communications at a UE in accordance with examples as disclosed herein. For example, the communications manager 1320 may be configured as or otherwise support a means for receiving, from a base station, control signaling indicating an OOD detection rule configuration for detecting a data sample that falls outside of a dataset used to train a first machine learning model. The communications manager 1320 may be configured as or otherwise support a means for determining that an OOD detection event has occurred based on determining that at least one data sample generated by the first machine learning model falls outside of the dataset based on the OOD detection rule configuration. The communications manager 1320 may be configured as or otherwise support a means for transmitting, to the base station, an indication that the OOD detection event has been determined for the at least one data sample.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, improved utilization of processing capability, etc. For example, the described techniques may improve machine learning models at the device 1305 (e.g., by detecting and reporting OOD events), which in turn provide a number of improvements and advantages at the device 1305.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of OOD detection and reporting for machine learning model deployment as described herein, or the processor 1340 and the memory 1330 may be otherwise configured to perform or support such operations.

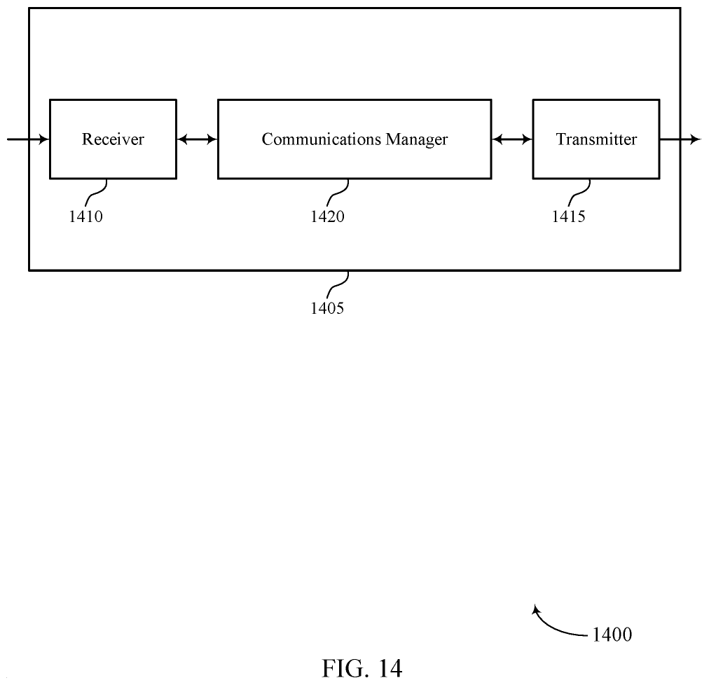

FIG. 14 shows a block diagram 1400 of a device 1405 that supports OOD detection and reporting for machine learning model deployment in accordance with aspects of the present disclosure. The device 1405 may be an example of aspects of a base station 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for receiving information such as packets, user data, control information, or any combination thereof associated with various information channels (e.g., control channels, data channels, information channels related to OOD detection and reporting for machine learning model deployment). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to OOD detection and reporting for machine learning model deployment). In some examples, the transmitter 1415 may be co-located with a receiver 1410 in a transceiver module. The transmitter 1415 may utilize a single antenna or a set of multiple antennas.

The communications manager 1420, the receiver 1410, the transmitter 1415, or various combinations thereof or various components thereof may be examples of means for performing various aspects of OOD detection and reporting for machine learning model deployment as described herein. For example, the communications manager 1420, the receiver 1410, the transmitter 1415, or various combinations or components thereof may support a method for performing one or more of the functions described herein.

In some examples, the communications manager 1420, the receiver 1410, the transmitter 1415, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1420, the receiver 1410, the transmitter 1415, or various combinations or components thereof may be implemented in code (e.g., as communications management software or firmware) executed by a processor. If implemented in code executed by a processor, the functions of the communications manager 1420, the receiver 1410, the transmitter 1415, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1420 may be configured to perform various operations (e.g., receiving, monitoring, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to receive information, transmit information, or perform various other operations as described herein.

The communications manager 1420 may support wireless communications at a base station in accordance with examples as disclosed herein. For example, the communications manager 1420 may be configured as or otherwise support a means for transmitting, to a UE, control signaling indicating an OOD detection rule configuration for configuring the UE to detect data samples that fall outside of a dataset used to train a first machine learning model of the UE. The communications manager 1420 may be configured as or otherwise support a means for receiving, from the UE, an indication that an OOD detection event has been determined for at least one data sample generated by the first machine learning model indicating that the at least one data sample falls outside of the dataset according to the OOD detection rule configuration.

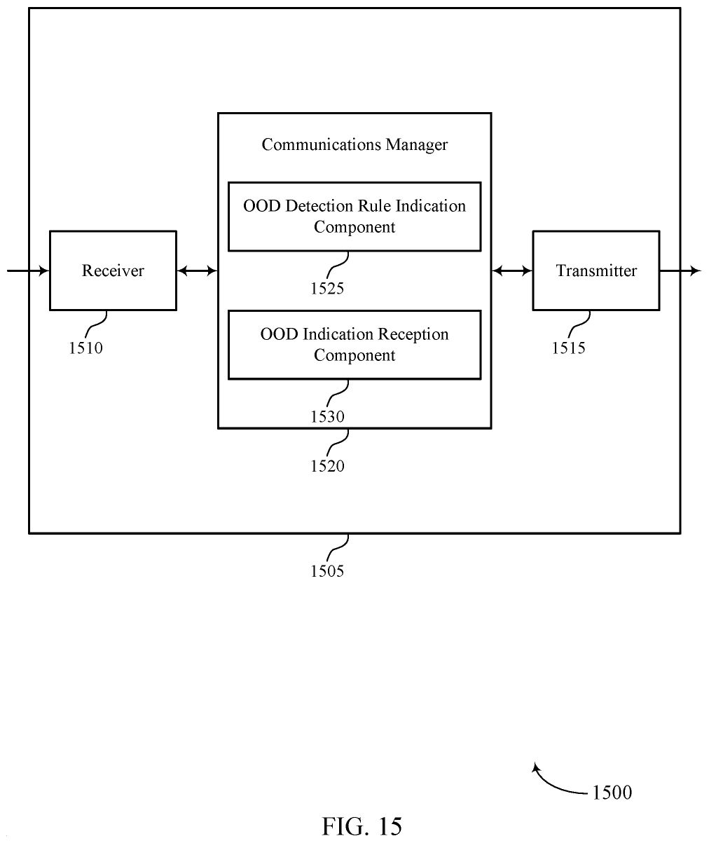

FIG. 15 shows a block diagram 1500 of a device 1505 that supports OOD detection and reporting for machine learning model deployment in accordance with aspects of the present disclosure. The device 1505 may be an example of aspects of a device 1405 or a base station 105 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for receiving information such as packets, user data, control information, or any combination thereof associated with various information channels (e.g., control channels, data channels, information channels related to OOD detection and reporting for machine learning model deployment). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to OOD detection and reporting for machine learning model deployment). In some examples, the transmitter 1515 may be co-located with a receiver 1510 in a transceiver module. The transmitter 1515 may utilize a single antenna or a set of multiple antennas.

The device 1505, or various components thereof, may be an example of means for performing various aspects of OOD detection and reporting for machine learning model deployment as described herein. For example, the communications manager 1520 may include a OOD detection rule indication component 1525 a OOD indication reception component 1530, or any combination thereof. The communications manager 1520 may be an example of aspects of a communications manager 1420 as described herein. In some examples, the communications manager 1520, or various components thereof, may be configured to perform various operations (e.g., receiving, monitoring, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to receive information, transmit information, or perform various other operations as described herein.

The communications manager 1520 may support wireless communications at a base station in accordance with examples as disclosed herein. The OOD detection rule indication component 1525 may be configured as or otherwise support a means for transmitting, to a UE, control signaling indicating an OOD detection rule configuration for configuring the UE to detect data samples that fall outside of a dataset used to train a first machine learning model of the UE. The OOD indication reception component 1530 may be configured as or otherwise support a means for receiving, from the UE, an indication that an OOD detection event has been determined for at least one data sample generated by the first machine learning model indicating that the at least one data sample falls outside of the dataset according to the OOD detection rule configuration.

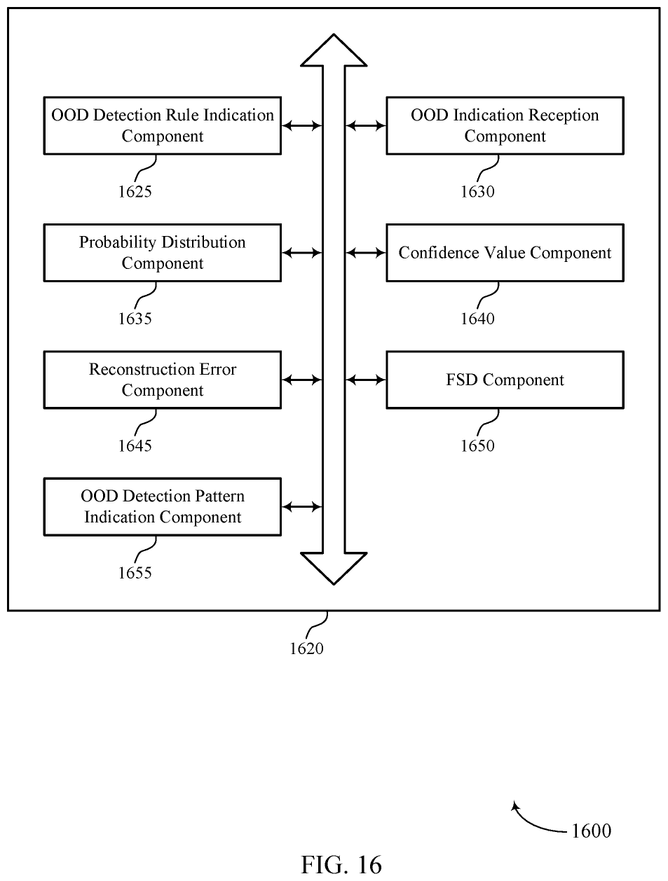

FIG. 16 shows a block diagram 1600 of a communications manager 1620 that supports OOD detection and reporting for machine learning model deployment in accordance with aspects of the present disclosure. The communications manager 1620 may be an example of aspects of a communications manager 1420, a communications manager 1520, or both, as described herein. The communications manager 1620, or various components thereof, may be an example of means for performing various aspects of OOD detection and reporting for machine learning model deployment as described herein. For example, the communications manager 1620 may include a OOD detection rule indication component 1625, a OOD indication reception component 1630, a probability distribution component 1635, a confidence value component 1640, a reconstruction error component 1645, an FSD component 1650, a OOD detection pattern indication component 1655, or any combination thereof. Each of these components may communicate, directly or indirectly, with one another (e.g., via one or more buses).

The communications manager 1620 may support wireless communications at a base station in accordance with examples as disclosed herein. The OOD detection rule indication component 1625 may be configured as or otherwise support a means for transmitting, to a UE, control signaling indicating an OOD detection rule configuration for configuring the UE to detect data samples that fall outside of a dataset used to train a first machine learning model of the UE. The OOD indication reception component 1630 may be configured as or otherwise support a means for receiving, from the UE, an indication that an OOD detection event has been determined for at least one data sample generated by the first machine learning model indicating that the at least one data sample falls outside of the dataset according to the OOD detection rule configuration.

In some examples, to support transmitting the control signaling, the OOD detection rule indication component 1625 may be configured as or otherwise support a means for transmitting, to the UE, the control signaling that indicates a model configuration for configuring the first machine learning model to generate the at least one data sample and that indicates the OOD detection rule configuration for configuring a second machine learning model for detecting data samples that fall outside of the dataset used to train the first machine learning model.

In some examples, to support transmitting the control signaling, the OOD detection rule indication component 1625 may be configured as or otherwise support a means for transmitting, to the UE, the control signaling that indicates a model configuration for configuring the first machine learning model to generate the at least one data sample and detect data samples that fall outside of the dataset used to train the first machine learning model.

In some examples, to support transmitting the control signaling, the OOD detection rule indication component 1625 may be configured as or otherwise support a means for transmitting the control signaling that jointly configures the UE with the OOD detection rule configuration and a model configuration for the first machine learning model.

In some examples, to support transmitting the control signaling, the OOD detection rule indication component 1625 may be configured as or otherwise support a means for transmitting the control signaling that indicates the OOD detection rule configuration that is a common OOD detection rule configuration for a set of multiple machine learning models.

In some examples, to support transmitting the control signaling, the probability distribution component 1635 may be configured as or otherwise support a means for transmitting the control signaling indicating the OOD detection rule configuration that indicates a probability distribution range for a probability distribution for data samples generated by the first machine learning model.

In some examples, to support receiving the indication that the OOD detection event has been determined, the probability distribution component 1635 may be configured as or otherwise support a means for receiving the indication based on the at least one data sample falling outside of the probability distribution range.

In some examples, to support transmitting the control signaling, the confidence value component 1640 may be configured as or otherwise support a means for transmitting the control signaling indicating the OOD detection rule configuration that indicates a confidence value threshold for the first machine learning model.

In some examples, to support receiving the indication that the OOD detection event has been determined, the confidence value component 1640 may be configured as or otherwise support a means for receiving the indication based on the at least one data sample satisfying the confidence value threshold.

In some examples, to support transmitting the control signaling, the reconstruction error component 1645 may be configured as or otherwise support a means for transmitting the control signaling indicating the OOD detection rule configuration that indicates a reconstruction error threshold for the first machine learning model.

In some examples, to support receiving the indication that the OOD detection event has been determined, the reconstruction error component 1645 may be configured as or otherwise support a means for receiving the indication based on the at least one data sample satisfying the reconstruction error threshold.

In some examples, to support transmitting the control signaling, the FSD component 1650 may be configured as or otherwise support a means for transmitting the control signaling indicating the OOD detection rule configuration that indicates a FSD range and a latent feature location for the first machine learning model.

In some examples, to support receiving the indication that the OOD detection event has been determined, the FSD component 1650 may be configured as or otherwise support a means for receiving the indication based on the at least one data sample falling outside of the FSD range relative to the latent feature location.

In some examples, to support transmitting the control signaling, the OOD detection pattern indication component 1655 may be configured as or otherwise support a means for transmitting the control signaling indicating the OOD detection rule configuration that indicates an OOD detection pattern, where the at least one data sample is determined to fall outside of the dataset according to the OOD detection pattern.

In some examples, the OOD detection pattern indicates a fixed period of instances for the UE to determine whether one or more data samples generated by the first machine learning model fall outside of the dataset used to train the first machine learning model.

In some examples, the OOD detection pattern indicates specific instances for the UE to determine whether one or more data samples generated by the first machine learning model fall outside of the dataset used to train the first machine learning model.

In some examples, to support transmitting the control signaling, the OOD detection pattern indication component 1655 may be configured as or otherwise support a means for transmitting the control signaling indicating the OOD detection rule configuration that indicates one or more parameters to implicitly indicate an OOD detection pattern.

In some examples, to support receiving the indication that the OOD detection event has been determined, the OOD indication reception component 1630 may be configured as or otherwise support a means for receiving the indication that indicates a measurement value for the at least one data sample.

In some examples, to support receiving the indication that the OOD detection event has been determined, the OOD indication reception component 1630 may be configured as or otherwise support a means for receiving the indication that the OOD detection event has been determined based on a reporting trigger condition being satisfied, a pre-defined reporting pattern, a reporting configuration, or a combination thereof.

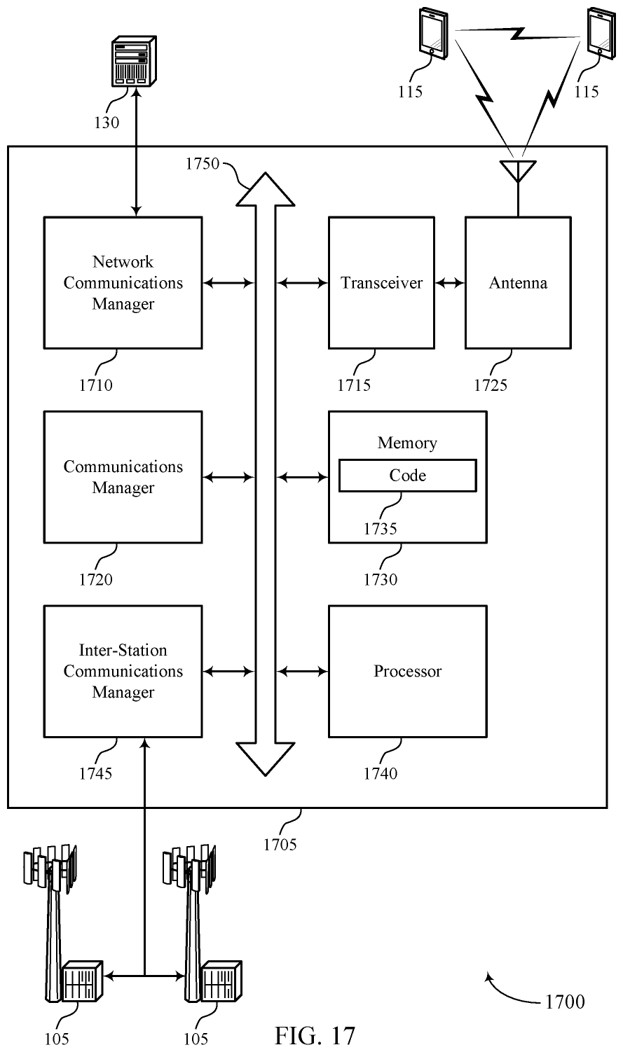

FIG. 17 shows a diagram of a system 1700 including a device 1705 that supports OOD detection and reporting for machine learning model deployment in accordance with aspects of the present disclosure. The device 1705 may be an example of or include the components of a device 1405, a device 1505, or a base station 105 as described herein. The device 1705 may communicate wirelessly with one or more base stations 105, UEs 115, or any combination thereof. The device 1705 may include components for bi-directional voice and data communications including components for transmitting and receiving communications, such as a communications manager 1720, a network communications manager 1710, a transceiver 1715, an antenna 1725, a memory 1730, code 1735, a processor 1740, and an inter-station communications manager 1745. These components may be in electronic communication or otherwise coupled (e.g., operatively, communicatively, functionally, electronically, electrically) via one or more buses (e.g., a bus 1750).

The network communications manager 1710 may manage communications with a core network 130 (e.g., via one or more wired backhaul links). For example, the network communications manager 1710 may manage the transfer of data communications for client devices, such as one or more UEs 115.

In some cases, the device 1705 may include a single antenna 1725. However, in some other cases the device 1705 may have more than one antenna 1725, which may be capable of concurrently transmitting or receiving multiple wireless transmissions. The transceiver 1715 may communicate bi-directionally, via the one or more antennas 1725, wired, or wireless links as described herein. For example, the transceiver 1715 may represent a wireless transceiver and may communicate bi-directionally with another wireless transceiver. The transceiver 1715 may also include a modem to modulate the packets, to provide the modulated packets to one or more antennas 1725 for transmission, and to demodulate packets received from the one or more antennas 1725. The transceiver 1715, or the transceiver 1715 and one or more antennas 1725, may be an example of a transmitter 1415, a transmitter 1515, a receiver 1410, a receiver 1510, or any combination thereof or component thereof, as described herein.

The memory 1730 may include RAM and ROM. The memory 1730 may store computer-readable, computer-executable code 1735 including instructions that, when executed by the processor 1740, cause the device 1705 to perform various functions described herein. The code 1735 may be stored in a non-transitory computer-readable medium such as system memory or another type of memory. In some cases, the code 1735 may not be directly executable by the processor 1740 but may cause a computer (e.g., when compiled and executed) to perform functions described herein. In some cases, the memory 1730 may contain, among other things, a BIOS which may control basic hardware or software operation such as the interaction with peripheral components or devices.

The processor 1740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1740 may be configured to operate a memory array using a memory controller. In some other cases, a memory controller may be integrated into the processor 1740. The processor 1740 may be configured to execute computer-readable instructions stored in a memory (e.g., the memory 1730) to cause the device 1705 to perform various functions (e.g., functions or tasks supporting OOD detection and reporting for machine learning model deployment). For example, the device 1705 or a component of the device 1705 may include a processor 1740 and memory 1730 coupled to the processor 1740, the processor 1740 and memory 1730 configured to perform various functions described herein.

The inter-station communications manager 1745 may manage communications with other base stations 105, and may include a controller or scheduler for controlling communications with UEs 115 in cooperation with other base stations 105. For example, the inter-station communications manager 1745 may coordinate scheduling for transmissions to UEs 115 for various interference mitigation techniques such as beamforming or joint transmission. In some examples, the inter-station communications manager 1745 may provide an X2 interface within an LTE/LTE-A wireless communications network technology to provide communication between base stations 105.

The communications manager 1720 may support wireless communications at a base station in accordance with examples as disclosed herein. For example, the communications manager 1720 may be configured as or otherwise support a means for transmitting, to a UE, control signaling indicating an OOD detection rule configuration for configuring the UE to detect data samples that fall outside of a dataset used to train a first machine learning model of the UE. The communications manager 1720 may be configured as or otherwise support a means for receiving, from the UE, an indication that an OOD detection event has been determined for at least one data sample generated by the first machine learning model indicating that the at least one data sample falls outside of the dataset according to the OOD detection rule configuration.

In some examples, the communications manager 1720 may be configured to perform various operations (e.g., receiving, monitoring, transmitting) using or otherwise in cooperation with the transceiver 1715, the one or more antennas 1725, or any combination thereof. Although the communications manager 1720 is illustrated as a separate component, in some examples, one or more functions described with reference to the communications manager 1720 may be supported by or performed by the processor 1740, the memory 1730, the code 1735, or any combination thereof. For example, the code 1735 may include instructions executable by the processor 1740 to cause the device 1705 to perform various aspects of OOD detection and reporting for machine learning model deployment as described herein, or the processor 1740 and the memory 1730 may be otherwise configured to perform or support such operations.

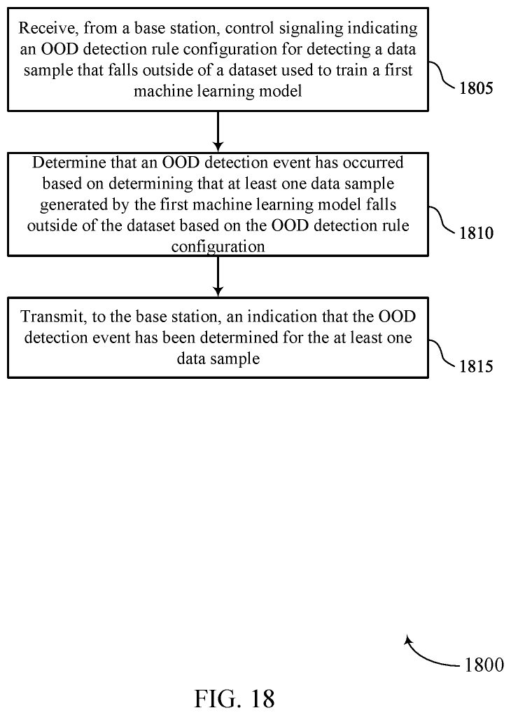

FIG. 18 shows a flowchart illustrating a method 1800 that supports OOD detection and reporting for machine learning model deployment in accordance with aspects of the present disclosure. The operations of the method 1800 may be implemented by a UE or its components as described herein. For example, the operations of the method 1800 may be performed by a UE 115 as described with reference to FIGS. 1 through 13. In some examples, a UE may execute a set of instructions to control the functional elements of the UE to perform the described functions. Additionally or alternatively, the UE may perform aspects of the described functions using special-purpose hardware.

At 1805, the method may include receiving, from a base station, control signaling indicating an OOD detection rule configuration for detecting a data sample that falls outside of a dataset used to train a first machine learning model. The operations of 1805 may be performed in accordance with examples as disclosed herein. In some examples, aspects of the operations of 1805 may be performed by a OOD detection rule component 1225 as described with reference to FIG. 12.

At 1810, the method may include determining that an OOD detection event has occurred based on determining that at least one data sample generated by the first machine learning model falls outside of the dataset based on the OOD detection rule configuration. The operations of 1810 may be performed in accordance with examples as disclosed herein. In some examples, aspects of the operations of 1810 may be performed by a OOD determination component 1230 as described with reference to FIG. 12.

At 1815, the method may include transmitting, to the base station, an indication that the OOD detection event has been determined for the at least one data sample. The operations of 1815 may be performed in accordance with examples as disclosed herein. In some examples, aspects of the operations of 1815 may be performed by a OOD indication component 1235 as described with reference to FIG. 12.

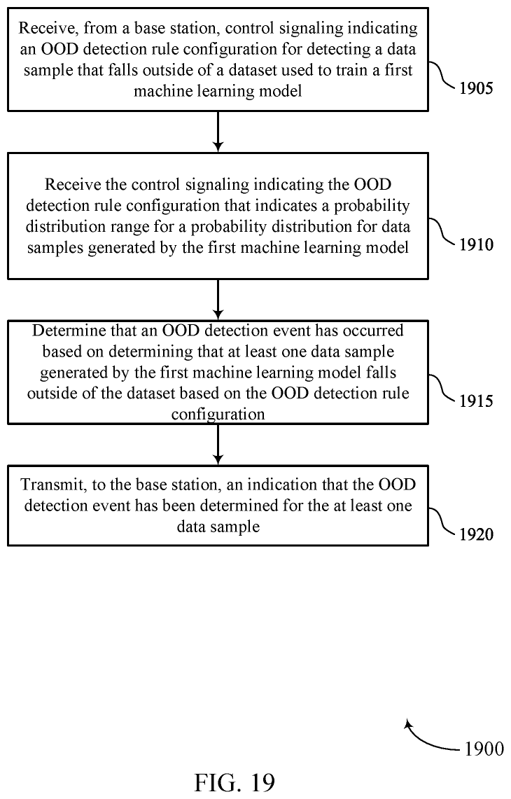

FIG. 19 shows a flowchart illustrating a method 1900 that supports OOD detection and reporting for machine learning model deployment in accordance with aspects of the present disclosure. The operations of the method 1900 may be implemented by a UE or its components as described herein. For example, the operations of the method 1900 may be performed by a UE 115 as described with reference to FIGS. 1 through 13. In some examples, a UE may execute a set of instructions to control the functional elements of the UE to perform the described functions. Additionally or alternatively, the UE may perform aspects of the described functions using special-purpose hardware.

At 1905, the method may include receiving, from a base station, control signaling indicating an OOD detection rule configuration for detecting a data sample that falls outside of a dataset used to train a first machine learning model. The operations of 1905 may be performed in accordance with examples as disclosed herein. In some examples, aspects of the operations of 1905 may be performed by a OOD detection rule component 1225 as described with reference to FIG. 12.

At 1910, the method may include receiving the control signaling indicating the OOD detection rule configuration that indicates a probability distribution range for a probability distribution for data samples generated by the first machine learning model. The operations of 1910 may be performed in accordance with examples as disclosed herein. In some examples, aspects of the operations of 1910 may be performed by a probability distribution component 1240 as described with reference to FIG. 12.

At 1915, the method may include determining that an OOD detection event has occurred based on determining that at least one data sample generated by the first machine learning model falls outside of the dataset based on the OOD detection rule configuration. The operations of 1915 may be performed in accordance with examples as disclosed herein. In some examples, aspects of the operations of 1915 may be performed by a OOD determination component 1230 as described with reference to FIG. 12.

At 1920, the method may include transmitting, to the base station, an indication that the OOD detection event has been determined for the at least one data sample. The operations of 1920 may be performed in accordance with examples as disclosed herein. In some examples, aspects of the operations of 1920 may be performed by a OOD indication component 1235 as described with reference to FIG. 12.

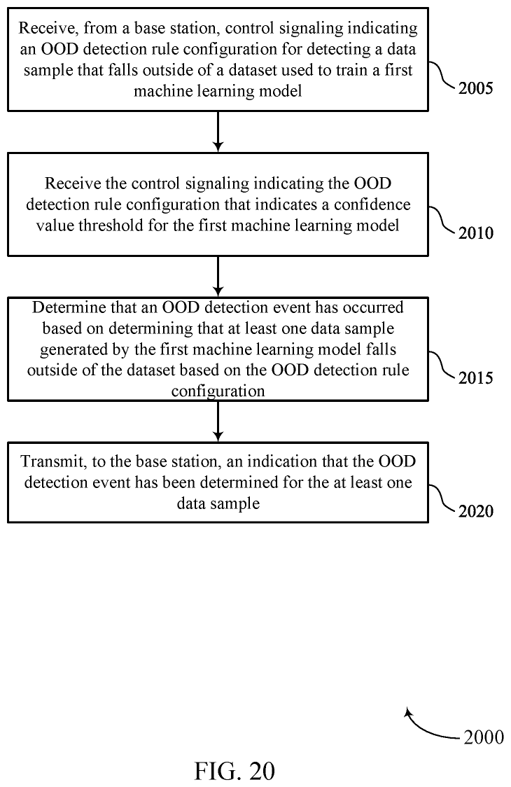

FIG. 20 shows a flowchart illustrating a method 2000 that supports OOD detection and reporting for machine learning model deployment in accordance with aspects of the present disclosure. The operations of the method 2000 may be implemented by a UE or its components as described herein. For example, the operations of the method 2000 may be performed by a UE 115 as described with reference to FIGS. 1 through 13. In some examples, a UE may execute a set of instructions to control the functional elements of the UE to perform the described functions. Additionally or alternatively, the UE may perform aspects of the described functions using special-purpose hardware.

At 2005, the method may include receiving, from a base station, control signaling indicating an OOD detection rule configuration for detecting a data sample that falls outside of a dataset used to train a first machine learning model. The operations of 2005 may be performed in accordance with examples as disclosed herein. In some examples, aspects of the operations of 2005 may be performed by a OOD detection rule component 1225 as described with reference to FIG. 12.

At 2010, the method may include receiving the control signaling indicating the OOD detection rule configuration that indicates a confidence value threshold for the first machine learning model. The operations of 2010 may be performed in accordance with examples as disclosed herein. In some examples, aspects of the operations of 2010 may be performed by a confidence value component 1245 as described with reference to FIG. 12.

At 2015, the method may include determining that an OOD detection event has occurred based on determining that at least one data sample generated by the first machine learning model falls outside of the dataset based on the OOD detection rule configuration. The operations of 2015 may be performed in accordance with examples as disclosed herein. In some examples, aspects of the operations of 2015 may be performed by a OOD determination component 1230 as described with reference to FIG. 12.

At 2020, the method may include transmitting, to the base station, an indication that the OOD detection event has been determined for the at least one data sample. The operations of 2020 may be performed in accordance with examples as disclosed herein. In some examples, aspects of the operations of 2020 may be performed by a OOD indication component 1235 as described with reference to FIG. 12.

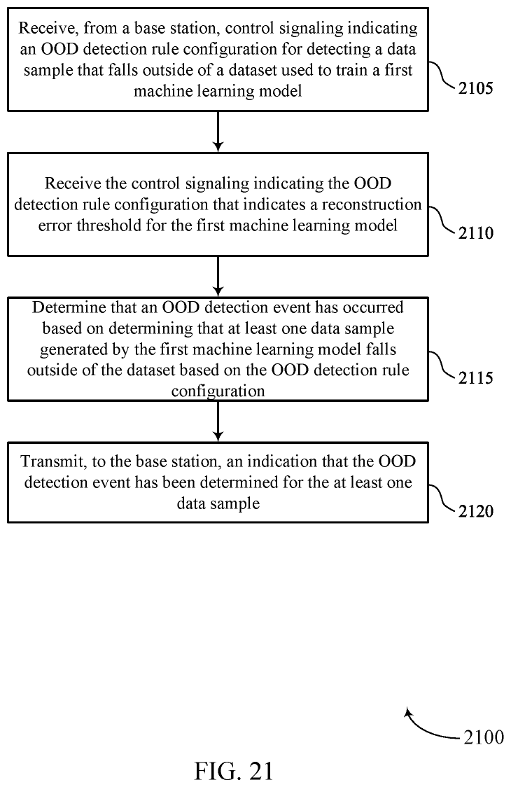

FIG. 21 shows a flowchart illustrating a method 2100 that supports OOD detection and reporting for machine learning model deployment in accordance with aspects of the present disclosure. The operations of the method 2100 may be implemented by a UE or its components as described herein. For example, the operations of the method 2100 may be performed by a UE 115 as described with reference to FIGS. 1 through 13. In some examples, a UE may execute a set of instructions to control the functional elements of the UE to perform the described functions. Additionally or alternatively, the UE may perform aspects of the described functions using special-purpose hardware.

At 2105, the method may include receiving, from a base station, control signaling indicating an OOD detection rule configuration for detecting a data sample that falls outside of a dataset used to train a first machine learning model. The operations of 2105 may be performed in accordance with examples as disclosed herein. In some examples, aspects of the operations of 2105 may be performed by a OOD detection rule component 1225 as described with reference to FIG. 12.

At 2110, the method may include receiving the control signaling indicating the OOD detection rule configuration that indicates a reconstruction error threshold for the first machine learning model. The operations of 2110 may be performed in accordance with examples as disclosed herein. In some examples, aspects of the operations of 2110 may be performed by a reconstruction error component 1250 as described with reference to FIG. 12.

At 2115, the method may include determining that an OOD detection event has occurred based on determining that at least one data sample generated by the first machine learning model falls outside of the dataset based on the OOD detection rule configuration. The operations of 2115 may be performed in accordance with examples as disclosed herein. In some examples, aspects of the operations of 2115 may be performed by a OOD determination component 1230 as described with reference to FIG. 12.

At 2120, the method may include transmitting, to the base station, an indication that the OOD detection event has been determined for the at least one data sample. The operations of 2120 may be performed in accordance with examples as disclosed herein. In some examples, aspects of the operations of 2120 may be performed by a OOD indication component 1235 as described with reference to FIG. 12.

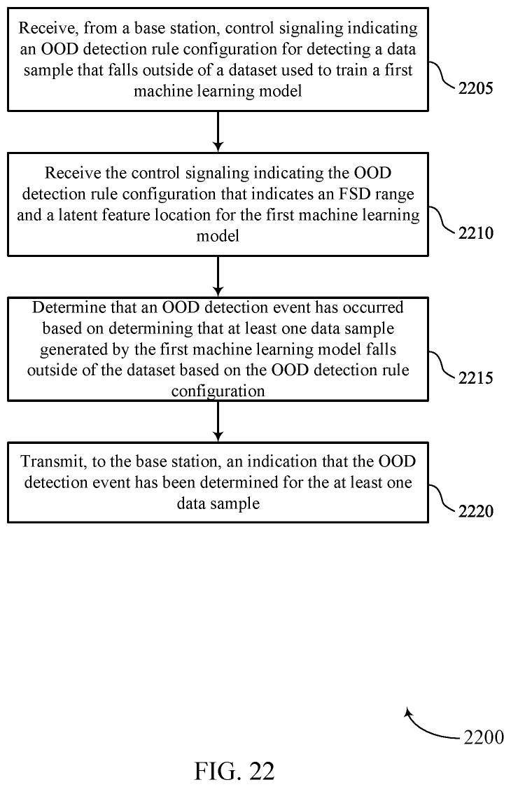

FIG. 22 shows a flowchart illustrating a method 2200 that supports OOD detection and reporting for machine learning model deployment in accordance with aspects of the present disclosure. The operations of the method 2200 may be implemented by a UE or its components as described herein. For example, the operations of the method 2200 may be performed by a UE 115 as described with reference to FIGS. 1 through 13. In some examples, a UE may execute a set of instructions to control the functional elements of the UE to perform the described functions. Additionally or alternatively, the UE may perform aspects of the described functions using special-purpose hardware.

At 2205, the method may include receiving, from a base station, control signaling indicating an OOD detection rule configuration for detecting a data sample that falls outside of a dataset used to train a first machine learning model. The operations of 2205 may be performed in accordance with examples as disclosed herein. In some examples, aspects of the operations of 2205 may be performed by a OOD detection rule component 1225 as described with reference to FIG. 12.

At 2210, the method may include receiving the control signaling indicating the OOD detection rule configuration that indicates a FSD range and a latent feature location for the first machine learning model. The operations of 2210 may be performed in accordance with examples as disclosed herein. In some examples, aspects of the operations of 2210 may be performed by an FSD component 1255 as described with reference to FIG. 12.

At 2215, the method may include determining that an OOD detection event has occurred based on determining that at least one data sample generated by the first machine learning model falls outside of the dataset based on the OOD detection rule configuration. The operations of 2215 may be performed in accordance with examples as disclosed herein. In some examples, aspects of the operations of 2215 may be performed by a OOD determination component 1230 as described with reference to FIG. 12.

At 2220, the method may include transmitting, to the base station, an indication that the OOD detection event has been determined for the at least one data sample. The operations of 2220 may be performed in accordance with examples as disclosed herein. In some examples, aspects of the operations of 2220 may be performed by a OOD indication component 1235 as described with reference to FIG. 12.

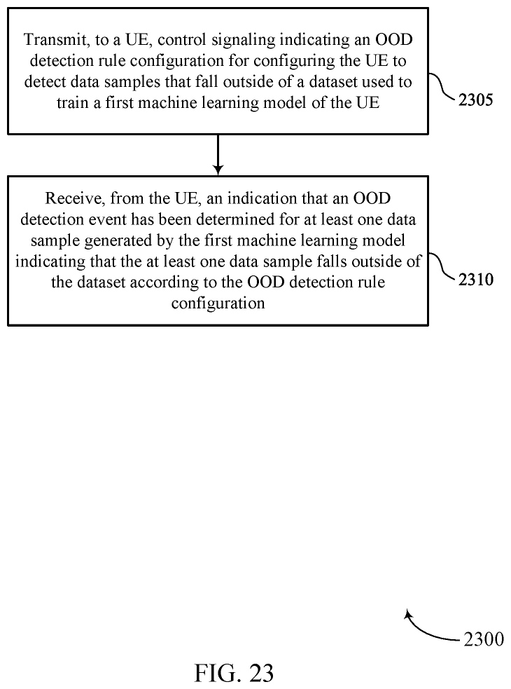

FIG. 23 shows a flowchart illustrating a method 2300 that supports OOD detection and reporting for machine learning model deployment in accordance with aspects of the present disclosure. The operations of the method 2300 may be implemented by a base station or its components as described herein. For example, the operations of the method 2300 may be performed by a base station 105 as described with reference to FIGS. 1 through 9 and 14 through 17. In some examples, a base station may execute a set of instructions to control the functional elements of the base station to perform the described functions. Additionally or alternatively, the base station may perform aspects of the described functions using special-purpose hardware.

At 2305, the method may include transmitting, to a UE, control signaling indicating an OOD detection rule configuration for configuring the UE to detect data samples that fall outside of a dataset used to train a first machine learning model of the UE. The operations of 2305 may be performed in accordance with examples as disclosed herein. In some examples, aspects of the operations of 2305 may be performed by a OOD detection rule indication component 1625 as described with reference to FIG. 16.

At 2310, the method may include receiving, from the UE, an indication that an OOD detection event has been determined for at least one data sample generated by the first machine learning model indicating that the at least one data sample falls outside of the dataset according to the OOD detection rule configuration. The operations of 2310 may be performed in accordance with examples as disclosed herein. In some examples, aspects of the operations of 2310 may be performed by a OOD indication reception component 1630 as described with reference to FIG. 16.

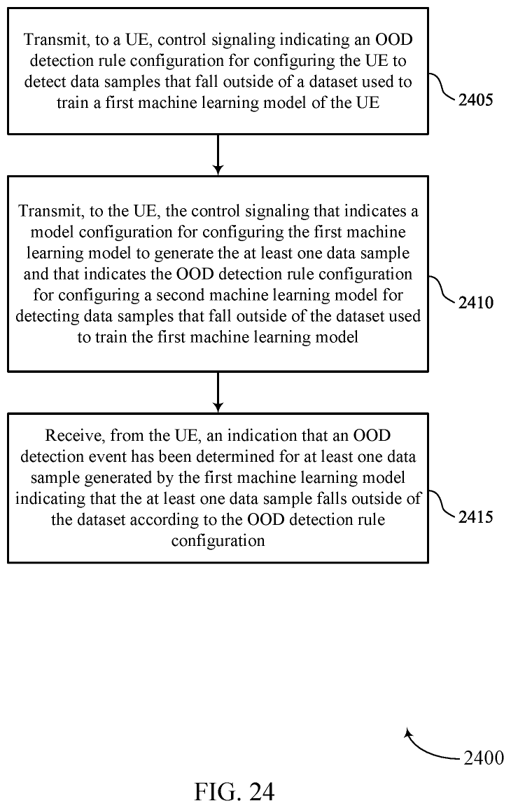

FIG. 24 shows a flowchart illustrating a method 2400 that supports OOD detection and reporting for machine learning model deployment in accordance with aspects of the present disclosure. The operations of the method 2400 may be implemented by a base station or its components as described herein. For example, the operations of the method 2400 may be performed by a base station 105 as described with reference to FIGS. 1 through 9 and 14 through 17. In some examples, a base station may execute a set of instructions to control the functional elements of the base station to perform the described functions. Additionally or alternatively, the base station may perform aspects of the described functions using special-purpose hardware.

At 2405, the method may include transmitting, to a UE, control signaling indicating an OOD detection rule configuration for configuring the UE to detect data samples that fall outside of a dataset used to train a first machine learning model of the UE. The operations of 2405 may be performed in accordance with examples as disclosed herein. In some examples, aspects of the operations of 2405 may be performed by a OOD detection rule indication component 1625 as described with reference to FIG. 16.

At 2410, the method may include transmitting, to the UE, the control signaling that indicates a model configuration for configuring the first machine learning model to generate the at least one data sample and that indicates the OOD detection rule configuration for configuring a second machine learning model for detecting data samples that fall outside of the dataset used to train the first machine learning model. The operations of 2410 may be performed in accordance with examples as disclosed herein. In some examples, aspects of the operations of 2410 may be performed by a OOD detection rule indication component 1625 as described with reference to FIG. 16.

At 2415, the method may include receiving, from the UE, an indication that an OOD detection event has been determined for at least one data sample generated by the first machine learning model indicating that the at least one data sample falls outside of the dataset according to the OOD detection rule configuration. The operations of 2415 may be performed in accordance with examples as disclosed herein. In some examples, aspects of the operations of 2415 may be performed by a OOD indication reception component 1630 as described with reference to FIG. 16.

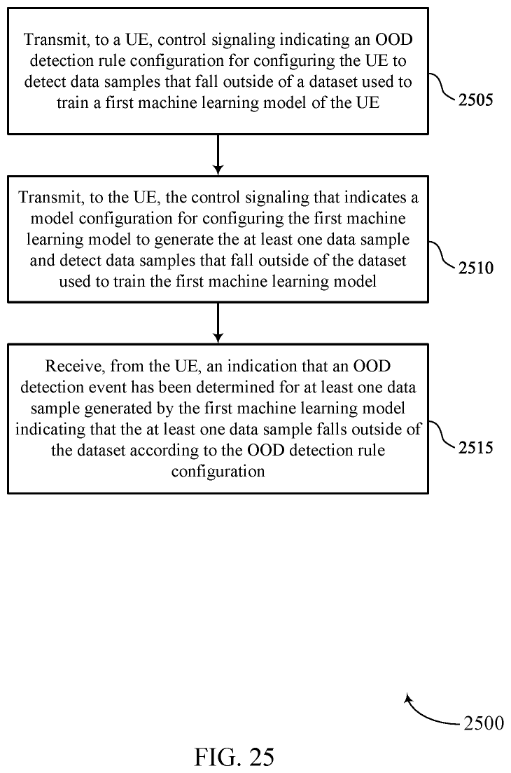

FIG. 25 shows a flowchart illustrating a method 2500 that supports OOD detection and reporting for machine learning model deployment in accordance with aspects of the present disclosure. The operations of the method 2500 may be implemented by a base station or its components as described herein. For example, the operations of the method 2500 may be performed by a base station 105 as described with reference to FIGS. 1 through 9 and 14 through 17. In some examples, a base station may execute a set of instructions to control the functional elements of the base station to perform the described functions. Additionally or alternatively, the base station may perform aspects of the described functions using special-purpose hardware.

At 2505, the method may include transmitting, to a UE, control signaling indicating an OOD detection rule configuration for configuring the UE to detect data samples that fall outside of a dataset used to train a first machine learning model of the UE. The operations of 2505 may be performed in accordance with examples as disclosed herein. In some examples, aspects of the operations of 2505 may be performed by a OOD detection rule indication component 1625 as described with reference to FIG. 16.

At 2510, the method may include transmitting, to the UE, the control signaling that indicates a model configuration for configuring the first machine learning model to generate the at least one data sample and detect data samples that fall outside of the dataset used to train the first machine learning model. The operations of 2510 may be performed in accordance with examples as disclosed herein. In some examples, aspects of the operations of 2510 may be performed by a OOD detection rule indication component 1625 as described with reference to FIG. 16.

At 2515, the method may include receiving, from the UE, an indication that an OOD detection event has been determined for at least one data sample generated by the first machine learning model indicating that the at least one data sample falls outside of the dataset according to the OOD detection rule configuration. The operations of 2515 may be performed in accordance with examples as disclosed herein. In some examples, aspects of the operations of 2515 may be performed by a OOD indication reception component 1630 as described with reference to FIG. 16.

The following provides an overview of aspects of the present disclosure:

Aspect 1: A method for wireless communications at a UE, comprising: receiving, from a base station, control signaling indicating an out-of-distribution detection rule configuration for detecting a data sample that falls outside of a dataset used to train a first machine learning model; determining that an out-of-distribution detection event has occurred based at least in part on determining that at least one data sample generated by the first machine learning model falls outside of the dataset based at least in part on the out-of-distribution detection rule configuration; and transmitting, to the base station, an indication that the out-of-distribution detection event has been determined for the at least one data sample.

Aspect 2: The method of aspect 1, wherein receiving the control signaling comprises: receiving, from the base station, the control signaling that indicates a model configuration for configuring the first machine learning model to generate the at least one data sample and that indicates the out-of-distribution detection rule configuration for configuring a second machine learning model for detecting data samples that fall outside of the dataset used to train the first machine learning model.

Aspect 3: The method of aspect 1, wherein receiving the control signaling comprises: receiving, from the base station, the control signaling that indicates a model configuration for configuring the first machine learning model to generate the at least one data sample and detect data samples that fall outside of the dataset used to train the first machine learning model.

Aspect 4: The method of any of aspects 1 through 3, wherein receiving the control signaling comprises: receiving the control signaling that jointly configures the UE with the out-of-distribution detection rule configuration and a model configuration for the first machine learning model.

Aspect 5: The method of any of aspects 1 through 3, wherein receiving the control signaling comprises: receiving the control signaling that indicates the out-of-distribution detection rule configuration that is a common out-of-distribution detection rule configuration for a plurality of machine learning models.

Aspect 6: The method of any of aspects 1 through 5, wherein receiving the control signaling comprises: receiving the control signaling indicating the out-of-distribution detection rule configuration that indicates a probability distribution range for a probability distribution for data samples generated by the first machine learning model.

Aspect 7: The method of aspect 6, wherein transmitting the indication that the out-of-distribution detection event has been determined comprises: transmitting the indication based at least in part on the at least one data sample falling outside of the probability distribution range.

Aspect 8: The method of any of aspects 1 through 5, wherein receiving the control signaling comprises: receiving the control signaling indicating the out-of-distribution detection rule configuration that indicates a confidence value threshold for the first machine learning model.

Aspect 9: The method of aspect 8, wherein transmitting the indication that the out-of-distribution detection event has been determined comprises: transmitting the indication based at least in part on the at least one data sample satisfying the confidence value threshold.

Aspect 10: The method of any of aspects 1 through 5, wherein receiving the control signaling comprises: receiving the control signaling indicating the out-of-distribution detection rule configuration that indicates a reconstruction error threshold for the first machine learning model.

Aspect 11: The method of aspect 10, wherein transmitting the indication that the out-of-distribution detection event has been determined comprises: transmitting the indication based at least in part on the at least one data sample satisfying the reconstruction error threshold.

Aspect 12: The method of any of aspects 1 through 5, wherein receiving the control signaling comprises: receiving the control signaling indicating the out-of-distribution detection rule configuration that indicates a feature statistics distribution range and a latent feature location for the first machine learning model.

Aspect 13: The method of aspect 12, wherein transmitting the indication that the out-of-distribution detection event has been determined comprises: transmitting the indication based at least in part on the at least one data sample falling outside of the feature statistics distribution range relative to the latent feature location.

Aspect 14: The method of any of aspects 1 through 13, wherein receiving the control signaling further comprises: receiving the control signaling indicating the out-of-distribution detection rule configuration that indicates an out-of-distribution detection pattern, wherein the at least one data sample is determined to fall outside of the dataset according to the out-of-distribution detection pattern.

Aspect 15: The method of aspect 14, wherein the out-of-distribution detection pattern indicates a fixed period of instances for the UE to determine whether one or more data samples generated by the first machine learning model fall outside of the dataset used to train the first machine learning model.

Aspect 16: The method of any of aspects 14 through 15, wherein the out-of-distribution detection pattern indicates specific instances for the UE to determine whether one or more data samples generated by the first machine learning model fall outside of the dataset used to train the first machine learning model.

Aspect 17: The method of any of aspects 1 through 13, wherein receiving the control signaling further comprising: receiving the control signaling indicating the out-of-distribution detection rule configuration that indicates one or more parameters to implicitly indicate an out-of-distribution detection pattern.

Aspect 18: The method of any of aspects 1 through 17, wherein transmitting the indication that the out-of-distribution detection event has been determined comprises: transmitting the indication that indicates a measurement value for the at least one data sample.

Aspect 19: The method of any of aspects 1 through 18, wherein transmitting the indication that the out-of-distribution detection event has been determined comprises: transmitting the indication that the out-of-distribution detection event has been determined based at least in part on a reporting trigger condition being satisfied, a pre-defined reporting pattern, a reporting configuration, or a combination thereof.

Aspect 20: A method for wireless communications at a base station, comprising: transmitting, to a UE, control signaling indicating an out-of-distribution detection rule configuration for configuring the UE to detect data samples that fall outside of a dataset used to train a first machine learning model of the UE; and receiving, from the UE, an indication that an out-of-distribution detection event has been determined for at least one data sample generated by the first machine learning model indicating that the at least one data sample falls outside of the dataset according to the out-of-distribution detection rule configuration.

Aspect 21: The method of aspect 20, wherein transmitting the control signaling comprises: transmitting, to the UE, the control signaling that indicates a model configuration for configuring the first machine learning model to generate the at least one data sample and that indicates the out-of-distribution detection rule configuration for configuring a second machine learning model for detecting data samples that fall outside of the dataset used to train the first machine learning model.

Aspect 22: The method of aspect 20, wherein transmitting the control signaling comprises: transmitting, to the UE, the control signaling that indicates a model configuration for configuring the first machine learning model to generate the at least one data sample and detect data samples that fall outside of the dataset used to train the first machine learning model.

Aspect 23: The method of any of aspects 20 through 22, wherein transmitting the control signaling comprises: transmitting the control signaling that jointly configures the UE with the out-of-distribution detection rule configuration and a model configuration for the first machine learning model.

Aspect 24: The method of any of aspects 20 through 22, wherein transmitting the control signaling comprises: transmitting the control signaling that indicates the out-of-distribution detection rule configuration that is a common out-of-distribution detection rule configuration for a plurality of machine learning models.

Aspect 25: The method of any of aspects 20 through 24, wherein transmitting the control signaling comprises: transmitting the control signaling indicating the out-of-distribution detection rule configuration that indicates a probability distribution range for a probability distribution for data samples generated by the first machine learning model.

Aspect 26: The method of aspect 25, wherein receiving the indication that the out-of-distribution detection event has been determined comprises: receiving the indication based at least in part on the at least one data sample falling outside of the probability distribution range.

Aspect 27: The method of any of aspects 20 through 24, wherein transmitting the control signaling comprises: transmitting the control signaling indicating the out-of-distribution detection rule configuration that indicates a confidence value threshold for the first machine learning model.

Aspect 28: The method of aspect 27, wherein receiving the indication that the out-of-distribution detection event has been determined comprises: receiving the indication based at least in part on the at least one data sample satisfying the confidence value threshold.

Aspect 29: The method of any of aspects 20 through 24, wherein transmitting the control signaling comprises: transmitting the control signaling indicating the out-of-distribution detection rule configuration that indicates a reconstruction error threshold for the first machine learning model.

Aspect 30: The method of aspect 29, wherein receiving the indication that the out-of-distribution detection event has been determined comprises: receiving the indication based at least in part on the at least one data sample satisfying the reconstruction error threshold.

Aspect 31: The method of any of aspects 20 through 24, wherein transmitting the control signaling comprises: transmitting the control signaling indicating the out-of-distribution detection rule configuration that indicates a feature statistics distribution range and a latent feature location for the first machine learning model.

Aspect 32: The method of aspect 31, wherein receiving the indication that the out-of-distribution detection event has been determined comprises: receiving the indication based at least in part on the at least one data sample falling outside of the feature statistics distribution range relative to the latent feature location.

Aspect 33: The method of any of aspects 20 through 32, wherein transmitting the control signaling comprises: transmitting the control signaling indicating the out-of-distribution detection rule configuration that indicates an out-of-distribution detection pattern, wherein the at least one data sample is determined to fall outside of the dataset according to the out-of-distribution detection pattern.

Aspect 34: The method of aspect 33, wherein the out-of-distribution detection pattern indicates a fixed period of instances for the UE to determine whether one or more data samples generated by the first machine learning model fall outside of the dataset used to train the first machine learning model.

Aspect 35: The method of any of aspects 33 through 34, wherein the out-of-distribution detection pattern indicates specific instances for the UE to determine whether one or more data samples generated by the first machine learning model fall outside of the dataset used to train the first machine learning model.

Aspect 36: The method of any of aspects 20 through 32, wherein transmitting the control signaling further comprises: transmitting the control signaling indicating the out-of-distribution detection rule configuration that indicates one or more parameters to implicitly indicate an out-of-distribution detection pattern.

Aspect 37: The method of any of aspects 20 through 36, wherein receiving the indication that the out-of-distribution detection event has been determined comprises: receiving the indication that indicates a measurement value for the at least one data sample.

Aspect 38: The method of any of aspects 20 through 37, wherein receiving the indication that the out-of-distribution detection event has been determined comprises: receiving the indication that the out-of-distribution detection event has been determined based at least in part on a reporting trigger condition being satisfied, a pre-defined reporting pattern, a reporting configuration, or a combination thereof.

Aspect 39: An apparatus for wireless communications at a UE, comprising a processor; memory coupled with the processor; and instructions stored in the memory and executable by the processor to cause the apparatus to perform a method of any of aspects 1 through 19.

Aspect 40: An apparatus for wireless communications at a UE, comprising at least one means for performing a method of any of aspects 1 through 19.

Aspect 41: A non-transitory computer-readable medium storing code for wireless communications at a UE, the code comprising instructions executable by a processor to perform a method of any of aspects 1 through 19.

Aspect 42: An apparatus for wireless communications at a base station, comprising a processor; memory coupled with the processor; and instructions stored in the memory and executable by the processor to cause the apparatus to perform a method of any of aspects 20 through 38.

Aspect 43: An apparatus for wireless communications at a base station, comprising at least one means for performing a method of any of aspects 20 through 38.

Aspect 44: A non-transitory computer-readable medium storing code for wireless communications at a base station, the code comprising instructions executable by a processor to perform a method of any of aspects 20 through 38.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving, from a base station, control signaling indicating an out-of-distribution detection rule configuration for detecting a data sample that falls outside of a dataset used to train a first machine learning model;
determining that an out-of-distribution detection event has occurred based at least in part on determining that at least one data sample generated by the first machine learning model falls outside of the dataset based at least in part on the out-of-distribution detection rule configuration; and
transmitting, to the base station, an indication that the out-of-distribution detection event has been determined for the at least one data sample.

2. The method of claim 1, wherein receiving the control signaling comprises:
receiving, from the base station, the control signaling that indicates a model configuration for configuring the first machine learning model to generate the at least one data sample and that indicates the out-of-distribution detection rule configuration for configuring a second machine learning model for detecting data samples that fall outside of the dataset used to train the first machine learning model.

3. The method of claim 1, wherein receiving the control signaling comprises:
receiving, from the base station, the control signaling that indicates a model configuration for configuring the first machine learning model to generate the at least one data sample and detect data samples that fall outside of the dataset used to train the first machine learning model.

4. The method of claim 1, wherein receiving the control signaling comprises:
receiving the control signaling that jointly configures the UE with the out-of-distribution detection rule configuration and a model configuration for the first machine learning model.

5. The method of claim 1, wherein receiving the control signaling comprises:
receiving the control signaling that indicates the out-of-distribution detection rule configuration that is a common out-of-distribution detection rule configuration for a plurality of machine learning models.

6. The method of claim 1, wherein receiving the control signaling comprises:
receiving the control signaling indicating the out-of-distribution detection rule configuration that indicates a probability distribution range for a probability distribution for data samples generated by the first machine learning model.

7. The method of claim 6, wherein transmitting the indication that the out-of-distribution detection event has been determined comprises:
transmitting the indication based at least in part on the at least one data sample falling outside of the probability distribution range.

8. The method of claim 1, wherein receiving the control signaling comprises:
receiving the control signaling indicating the out-of-distribution detection rule configuration that indicates a confidence value threshold for the first machine learning model.

9. The method of claim 8, wherein transmitting the indication that the out-of-distribution detection event has been determined comprises:
transmitting the indication based at least in part on the at least one data sample satisfying the confidence value threshold.

10. The method of claim 1, wherein receiving the control signaling comprises:
receiving the control signaling indicating the out-of-distribution detection rule configuration that indicates a reconstruction error threshold for the first machine learning model.

11. The method of claim 10, wherein transmitting the indication that the out-of-distribution detection event has been determined comprises:
transmitting the indication based at least in part on the at least one data sample satisfying the reconstruction error threshold.

12. The method of claim 1, wherein receiving the control signaling comprises:
receiving the control signaling indicating the out-of-distribution detection rule configuration that indicates a feature statistics distribution range and a latent feature location for the first machine learning model.

13. The method of claim 12, wherein transmitting the indication that the out-of-distribution detection event has been determined comprises:
transmitting the indication based at least in part on the at least one data sample falling outside of the feature statistics distribution range relative to the latent feature location.

14. The method of claim 1, wherein receiving the control signaling further comprises:
receiving the control signaling indicating the out-of-distribution detection rule configuration that indicates an out-of-distribution detection pattern, wherein the at least one data sample is determined to fall outside of the dataset according to the out-of-distribution detection pattern.

15. The method of claim 14, wherein the out-of-distribution detection pattern indicates a fixed period of instances for the UE to determine whether one or more data samples generated by the first machine learning model fall outside of the dataset used to train the first machine learning model.

16. The method of claim 14, wherein the out-of-distribution detection pattern indicates specific instances for the UE to determine whether one or more data samples generated by the first machine learning model fall outside of the dataset used to train the first machine learning model.

17. The method of claim 1, wherein receiving the control signaling further comprising:
receiving the control signaling indicating the out-of-distribution detection rule configuration that indicates one or more parameters to implicitly indicate an out-of-distribution detection pattern.

18. The method of claim 1, wherein transmitting the indication that the out-of-distribution detection event has been determined comprises:
transmitting the indication that indicates a measurement value for the at least one data sample.

19. The method of claim 1, wherein transmitting the indication that the out-of-distribution detection event has been determined comprises:
transmitting the indication that the out-of-distribution detection event has been determined based at least in part on a reporting trigger condition being satisfied, a pre-defined reporting pattern, a reporting configuration, or a combination thereof.

20. A method for wireless communications at a base station, comprising:
transmitting, to a user equipment (UE), control signaling indicating an out-of-distribution detection rule configuration for configuring the UE to detect data samples that fall outside of a dataset used to train a first machine learning model of the UE; and
receiving, from the UE, an indication that an out-of-distribution detection event has been determined for at least one data sample generated by the first machine learning model indicating that the at least one data sample falls outside of the dataset according to the out-of-distribution detection rule configuration.

21. The method of claim 20, wherein transmitting the control signaling comprises:
transmitting, to the UE, the control signaling that indicates a model configuration for configuring the first machine learning model to generate the at least one data sample and that indicates the out-of-distribution detection rule configuration for configuring a second machine learning model for detecting data samples that fall outside of the dataset used to train the first machine learning model.

22. The method of claim 20, wherein transmitting the control signaling comprises:
transmitting, to the UE, the control signaling that indicates a model configuration for configuring the first machine learning model to generate the at least one data sample and detect data samples that fall outside of the dataset used to train the first machine learning model.

23. The method of claim 20, wherein transmitting the control signaling comprises:
transmitting the control signaling indicating the out-of-distribution detection rule configuration that indicates a probability distribution range for a probability distribution for data samples generated by the first machine learning model.

24. The method of claim 20, wherein transmitting the control signaling comprises:
transmitting the control signaling indicating the out-of-distribution detection rule configuration that indicates a confidence value threshold for the first machine learning model.

25. The method of claim 20, wherein transmitting the control signaling comprises:
transmitting the control signaling indicating the out-of-distribution detection rule configuration that indicates a reconstruction error threshold for the first machine learning model.

26. The method of claim 20, wherein transmitting the control signaling comprises:
transmitting the control signaling indicating the out-of-distribution detection rule configuration that indicates a feature statistics distribution range and a latent feature location for the first machine learning model.

27. The method of claim 20, wherein transmitting the control signaling comprises:
transmitting the control signaling indicating the out-of-distribution detection rule configuration that indicates an out-of-distribution detection pattern, wherein the at least one data sample is determined to fall outside of the dataset according to the out-of-distribution detection pattern.

28. The method of claim 20, wherein transmitting the control signaling further comprises:
transmitting the control signaling indicating the out-of-distribution detection rule configuration that indicates one or more parameters to implicitly indicate an out-of-distribution detection pattern.

29. An apparatus for wireless communications at a user equipment (UE), comprising:
a processor;
memory coupled with the processor; and
instructions stored in the memory and executable by the processor to cause the apparatus to:
receive, from a base station, control signaling indicating an out-of-distribution detection rule configuration for detecting a data sample that falls outside of a dataset used to train a first machine learning model;
determine that an out-of-distribution detection event has occurred based at least in part on determining that at least one data sample generated by the first machine learning model falls outside of the dataset based at least in part on the out-of-distribution detection rule configuration; and
transmit, to the base station, an indication that the out-of-distribution detection event has been determined for the at least one data sample.

30. The apparatus of claim 29, wherein the instructions to receive the control signaling are executable by the processor to cause the apparatus to:
receive, from the base station, the control signaling that indicates a model configuration for configuring the first machine learning model to generate the at least one data sample and that indicates the out-of-distribution detection rule configuration for configuring a second machine learning model for detecting data samples that fall outside of the dataset used to train the first machine learning model.

31. The apparatus of claim 29, wherein the instructions to receive the control signaling are executable by the processor to cause the apparatus to:
receive, from the base station, the control signaling that indicates a model configuration for configuring the first machine learning model to generate the at least one data sample and detect data samples that fall outside of the dataset used to train the first machine learning model.

32. The apparatus of claim 29, wherein the instructions to receive the control signaling are executable by the processor to cause the apparatus to:
receive the control signaling that jointly configures the UE with the out-of-distribution detection rule configuration and a model configuration for the first machine learning model.

33. The apparatus of claim 29, wherein the instructions to receive the control signaling are executable by the processor to cause the apparatus to:
receive the control signaling that indicates the out-of-distribution detection rule configuration that is a common out-of-distribution detection rule configuration for a plurality of machine learning models.

34. The apparatus of claim 29, wherein the instructions to receive the control signaling are executable by the processor to cause the apparatus to:
receive the control signaling indicating the out-of-distribution detection rule configuration that indicates a probability distribution range for a probability distribution for data samples generated by the first machine learning model.

35. The apparatus of claim 34, wherein the instructions to transmit the indication that the out-of-distribution detection event has been determined are executable by the processor to cause the apparatus to:
transmit the indication based at least in part on the at least one data sample falling outside of the probability distribution range.

36. The apparatus of claim 29, wherein the instructions to receive the control signaling are executable by the processor to cause the apparatus to:
receive the control signaling indicating the out-of-distribution detection rule configuration that indicates a confidence value threshold for the first machine learning model.

37. The apparatus of claim 36, wherein the instructions to transmit the indication that the out-of-distribution detection event has been determined are executable by the processor to cause the apparatus to:
transmit the indication based at least in part on the at least one data sample satisfying the confidence value threshold.

38. The apparatus of claim 29, wherein the instructions to receive the control signaling are executable by the processor to cause the apparatus to:
receive the control signaling indicating the out-of-distribution detection rule configuration that indicates a reconstruction error threshold for the first machine learning model.

39. The apparatus of claim 38, wherein the instructions to transmit the indication that the out-of-distribution detection event has been determined are executable by the processor to cause the apparatus to:
transmit the indication based at least in part on the at least one data sample satisfying the reconstruction error threshold.

40. The apparatus of claim 29, wherein the instructions to receive the control signaling are executable by the processor to cause the apparatus to:
receive the control signaling indicating the out-of-distribution detection rule configuration that indicates a feature statistics distribution range and a latent feature location for the first machine learning model.

41. The apparatus of claim 40, wherein the instructions to transmit the indication that the out-of-distribution detection event has been determined are executable by the processor to cause the apparatus to:
transmit the indication based at least in part on the at least one data sample falling outside of the feature statistics distribution range relative to the latent feature location.

42. The apparatus of claim 29, wherein the instructions to receive the control signaling are further executable by the processor to cause the apparatus to:
receive the control signaling indicating the out-of-distribution detection rule configuration that indicates an out-of-distribution detection pattern, wherein the at least one data sample is determined to fall outside of the dataset according to the out-of-distribution detection pattern.

43. The apparatus of claim 29, wherein the instructions are further executable by the processor to cause the apparatus to:
receive the control signaling indicating the out-of-distribution detection rule configuration that indicates one or more parameters to implicitly indicate an out-of-distribution detection pattern.

44. The apparatus of claim 29, wherein the instructions to transmit the indication that the out-of-distribution detection event has been determined are executable by the processor to cause the apparatus to:
transmit the indication that indicates a measurement value for the at least one data sample.

45. The apparatus of claim 29, wherein the instructions to transmit the indication that the out-of-distribution detection event has been determined are executable by the processor to cause the apparatus to:
transmit the indication that the out-of-distribution detection event has been determined based at least in part on a reporting trigger condition being satisfied, a pre-defined reporting pattern, a reporting configuration, or a combination thereof.

46. An apparatus for wireless communications at a base station, comprising:
a processor;
memory coupled with the processor; and
instructions stored in the memory and executable by the processor to cause the apparatus to:
transmit, to a user equipment (UE), control signaling indicating an out-of-distribution detection rule configuration for configuring the UE to detect data samples that fall outside of a dataset used to train a first machine learning model of the UE; and
receive, from the UE, an indication that an out-of-distribution detection event has been determined for at least one data sample generated by the first machine learning model indicating that the at least one data sample falls outside of the dataset according to the out-of-distribution detection rule configuration.

47. The apparatus of claim 46, wherein the instructions to transmit the control signaling are executable by the processor to cause the apparatus to:
transmit, to the UE, the control signaling that indicates a model configuration for configuring the first machine learning model to generate the at least one data sample and that indicates the out-of-distribution detection rule configuration for configuring a second machine learning model for detecting data samples that fall outside of the dataset used to train the first machine learning model.

48. The apparatus of claim 46, wherein the instructions to transmit the control signaling are executable by the processor to cause the apparatus to:
transmit the control signaling indicating the out-of-distribution detection rule configuration that indicates a probability distribution range for a probability distribution for data samples generated by the first machine learning model.

49. The apparatus of claim 46, wherein the instructions to transmit the control signaling are executable by the processor to cause the apparatus to:
transmit the control signaling indicating the out-of-distribution detection rule configuration that indicates a confidence value threshold for the first machine learning model.

50. The apparatus of claim 46, wherein the instructions to transmit the control signaling are executable by the processor to cause the apparatus to:
transmit the control signaling indicating the out-of-distribution detection rule configuration that indicates a reconstruction error threshold for the first machine learning model.

51. The apparatus of claim 46, wherein the instructions to transmit the control signaling are executable by the processor to cause the apparatus to:
transmit the control signaling indicating the out-of-distribution detection rule configuration that indicates a feature statistics distribution range and a latent feature location for the first machine learning model.

52. The apparatus of claim 46, wherein the instructions to transmit the control signaling are executable by the processor to cause the apparatus to:
transmit the control signaling indicating the out-of-distribution detection rule configuration that indicates an out-of-distribution detection pattern, wherein the at least one data sample is determined to fall outside of the dataset according to the out-of-distribution detection pattern.

53. The apparatus of claim 46, wherein the instructions to transmit the control signaling are further executable by the processor to cause the apparatus to:
transmit the control signaling indicating the out-of-distribution detection rule configuration that indicates one or more parameters to implicitly indicate an out-of-distribution detection pattern.

54. An apparatus for wireless communications at a user equipment (UE), comprising:
means for receiving, from a base station, control signaling indicating an out-of-distribution detection rule configuration for detecting a data sample that falls outside of a dataset used to train a first machine learning model;
means for determining that an out-of-distribution detection event has occurred based at least in part on determining that at least one data sample generated by the first machine learning model falls outside of the dataset based at least in part on the out-of-distribution detection rule configuration; and
means for transmitting, to the base station, an indication that the out-of-distribution detection event has been determined for the at least one data sample.

55. An apparatus for wireless communications at a base station, comprising:
means for transmitting, to a user equipment (UE), control signaling indicating an out-of-distribution detection rule configuration for configuring the UE to detect data samples that fall outside of a dataset used to train a first machine learning model of the UE; and
means for receiving, from the UE, an indication that an out-of-distribution detection event has been determined for at least one data sample generated by the first machine learning model indicating that the at least one data sample falls outside of the dataset according to the out-of-distribution detection rule configuration.

56. A non-transitory computer-readable medium storing code for wireless communications at a user equipment (UE), the code comprising instructions executable by a processor to:
receive, from a base station, control signaling indicating an out-of-distribution detection rule configuration for detecting a data sample that falls outside of a dataset used to train a first machine learning model;
determine that an out-of-distribution detection event has occurred based at least in part on determining that at least one data sample generated by the first machine learning model falls outside of the dataset based at least in part on the out-of-distribution detection rule configuration; and
transmit, to the base station, an indication that the out-of-distribution detection event has been determined for the at least one data sample.

57. A non-transitory computer-readable medium storing code for wireless communications at a base station, the code comprising instructions executable by a processor to:
transmit, to a user equipment (UE), control signaling indicating an out-of-distribution detection rule configuration for configuring the UE to detect data samples that fall outside of a dataset used to train a first machine learning model of the UE; and
receive, from the UE, an indication that an out-of-distribution detection event has been determined for at least one data sample generated by the first machine learning model indicating that the at least one data sample falls outside of the dataset according to the out-of-distribution detection rule configuration.
